(19) United States
(12) Patent Application Publication
(10) Pub. No.: US 2024/0405845 A1
(43) Pub. Date: Dec. 5, 2024

(54) TECHNIQUES FOR BEAM DETERMINATION AND REPORTING IN BACKSCATTER COMMUNICATION

(71) Applicant: QUALCOMM Incorporated, San Diego, CA (US)

(72) Inventors: Min HUANG, Beijing (CN); Chao WEI, Beijing (CN); Hao XU, Beijing (CN)

(21) Appl. No.: 18/698,345

(22) PCT Filed: Dec. 28, 2021
(86) PCT No.: PCT/CN2021/142040

§ 371 Date: Apr. 3, 2024

(51) Int. Cl. H04B 7/08; H04B 7/04; H04B 7/06

(52) U.S. Cl. CPC H04B 7/088; H04B 7/04013; H04B 7/0626; H04B 7/0632; H04B 7/06968

(57) ABSTRACT

Various aspects of the present disclosure generally relate to wireless communication. In some aspects, a user equipment (UE) may receive, from a base station, a configuration of a beam report associated with a set of base station transmit beams, the set of base station transmit beams being directed to the UE via a backscatter link reflected by a backscatter device. The UE may transmit, to the base station, the beam report based at least in part on the configuration of the beam report, the beam report corresponding to the backscatter link. Numerous other aspects are described.

### FIELD OF THE DISCLOSURE

Aspects of the present disclosure generally relate to wireless communication and to techniques and apparatuses for beam determination and reporting in backscatter communication.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a base station, a configuration of a beam report associated with a set of base station transmit beams, the set of base station transmit beams being directed to the UE via a backscatter link reflected by a backscatter device. The method may include transmitting, to the base station, the beam report based at least in part on the configuration of the beam report, the beam report corresponding to the backscatter link.

Some aspects described herein relate to a method of wireless communication performed by a UE. The method may include receiving, from a base station, a configuration of an uplink transmission, wherein the UE is in wireless communication with the base station via a direct link and via a backscatter link reflected by a backscatter device. The method may include transmitting, to the base station and based at least in part on the configuration, the uplink transmission via the direct link and via the backscatter link during a period of mandatory reflection associated with the backscatter device.

Some aspects described herein relate to a method of wireless communication performed by a base station. The method may include transmitting, to a UE, a configuration of a beam report associated with a set of base station transmit beams, the set of base station transmit beams being directed to the UE via a backscatter link reflected by a backscatter device. The method may include receiving, from the UE, the beam report based at least in part on the configuration of the beam report, the beam report corresponding to the backscatter link.

Some aspects described herein relate to a method of wireless communication performed by a base station. The method may include transmitting, to a UE, a configuration of an uplink transmission, wherein the UE is in wireless communication with the base station via a direct link and via a backscatter link reflected by a backscatter device. The method may include transmitting, to the backscatter device, a configuration of a period of mandatory reflection. The method may include receiving, from the UE and based at least in part on the configuration of the uplink transmission, the uplink transmission via the direct link and via the backscatter link during the period of mandatory reflection.

Some aspects described herein relate to an apparatus for wireless communication at a UE. The apparatus may include a memory and one or more processors coupled to the memory. The one or more processors may be configured to receive, from a base station, a configuration of a beam report associated with a set of base station transmit beams, the set of base station transmit beams being directed to the UE via a backscatter link reflected by a backscatter device. The one or more processors may be configured to transmit, to the base station, the beam report based at least in part on the configuration of the beam report, the beam report corresponding to the backscatter link.

Some aspects described herein relate to an apparatus for wireless communication at a UE. The apparatus may include a memory and one or more processors coupled to the memory. The one or more processors may be configured to receive, from a base station, a configuration of an uplink transmission, wherein the UE is in wireless communication with the base station via a direct link and via a backscatter link reflected by a backscatter device. The one or more processors may be configured to transmit, to the base station and based at least in part on the configuration, the uplink transmission via the direct link and via the backscatter link during a period of mandatory reflection associated with the backscatter device.

Some aspects described herein relate to an apparatus for wireless communication at a base station. The apparatus may include a memory and one or more processors coupled to the memory. The one or more processors may be configured to transmit, to a UE, a configuration of a beam report associated with a set of base station transmit beams, the set of base station transmit beams being directed to the UE via a backscatter link reflected by a backscatter device. The one or more processors may be configured to receive, from the UE, the beam report based at least in part on the configuration of the beam report, the beam report corresponding to the backscatter link.

Some aspects described herein relate to an apparatus for wireless communication at a base station. The base station may include a memory and one or more processors coupled to the memory. The one or more processors may be configured to transmit, to a UE, a configuration of an uplink transmission, wherein the UE is in wireless communication with the base station via a direct link and via a backscatter link reflected by a backscatter device. The one or more processors may be configured to transmit, to the backscatter device, a configuration of a period of mandatory reflection. The one or more processors may be configured to receive, from the UE and based at least in part on the configuration of the uplink transmission, the uplink transmission via the direct link and via the backscatter link during the period of mandatory reflection.

Some aspects described herein relate to a non-transitory computer-readable medium that stores a set of instructions for wireless communication by a UE. The set of instructions, when executed by one or more processors of the UE, may cause the UE to receive, from a base station, a configuration of a beam report associated with a set of base station transmit beams, the set of base station transmit beams being directed to the UE via a backscatter link reflected by a backscatter device. The set of instructions, when executed by one or more processors of the UE, may cause the UE to transmit, to the base station, the beam report based at least in part on the configuration of the beam report, the beam report corresponding to the backscatter link.

Some aspects described herein relate to a non-transitory computer-readable medium that stores a set of instructions for wireless communication by a UE. The set of instructions, when executed by one or more processors of a UE, may cause UE to receive, from a base station, a configuration of an uplink transmission, wherein the UE is in wireless communication with the base station via a direct link and via a backscatter link reflected by a backscatter device. The set of instructions, when executed by one or more processors of a UE, may cause the UE to transmit, to the base station and based at least in part on the configuration, the uplink transmission via the direct link and via the backscatter link during a period of mandatory reflection associated with the backscatter device.

Some aspects described herein relate to a non-transitory computer-readable medium that stores a set of instructions for wireless communication by a base station. The set of instructions, when executed by one or more processors of the base station, may cause the base station to transmit, to a UE, a configuration of a beam report associated with a set of base station transmit beams, the set of base station transmit beams being directed to the UE via a backscatter link reflected by a backscatter device. The set of instructions, when executed by one or more processors of the base station, may cause the base station to receive, from the UE, the beam report based at least in part on the configuration of the beam report, the beam report corresponding to the backscatter link.

Some aspects described herein relate to a non-transitory computer-readable medium that stores a set of instructions for wireless communication by a base station. The set of instructions, when executed by one or more processors of the base station, may cause the base station to transmit, to a UE, a configuration of an uplink transmission, wherein the UE is in wireless communication with the base station via a direct link and via a backscatter link reflected by a backscatter device. The set of instructions, when executed by one or more processors of the base station, may cause the base station to transmit, to the backscatter device, a configuration of a period of mandatory reflection. The set of instructions, when executed by one or more processors of the base station, may cause the base station to receive, from the UE and based at least in part on the configuration of the uplink transmission, the uplink transmission via the direct link and via the backscatter link during the period of mandatory reflection.

Some aspects described herein relate to an apparatus for wireless communication. The apparatus may include means for receiving, from a base station, a configuration of a beam report associated with a set of base station transmit beams, the set of base station transmit beams being directed to the apparatus via a backscatter link reflected by a backscatter device. The apparatus may include means for transmitting, to the base station, the beam report based at least in part on the configuration of the beam report, the beam report corresponding to the backscatter link.

Some aspects described herein relate to an apparatus for wireless communication. The apparatus may include means for receiving, from a base station, a configuration of an uplink transmission, wherein the apparatus is in wireless communication with the base station via a direct link and via a backscatter link reflected by a backscatter device. The apparatus may include means for transmitting, to the base station and based at least in part on the configuration, the uplink transmission via the direct link and via the backscatter link during a period of mandatory reflection associated with the backscatter device.

Some aspects described herein relate to an apparatus for wireless communication. The apparatus may include means for transmitting, to a UE, a configuration of a beam report associated with a set of base station transmit beams, the set of base station transmit beams being directed to the UE via a backscatter link reflected by a backscatter device. The apparatus may include means for receiving, from the UE, the beam report based at least in part on the configuration of the beam report, the beam report corresponding to the backscatter link.

Some aspects described herein relate to an apparatus for wireless communication. The apparatus may include means for transmitting, to a UE, a configuration of an uplink transmission, wherein the UE is in wireless communication with the apparatus via a direct link and via a backscatter link reflected by a backscatter device. The apparatus may include means for transmitting, to the backscatter device, a configuration of a period of mandatory reflection. The apparatus may include means for receiving, from the UE and based at least in part on the configuration of the uplink transmission, the uplink transmission via the direct link and via the backscatter link during the period of mandatory reflection.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of backscatter communication, in accordance with the present disclosure.

FIG. 4 is a diagram illustrating examples of channel station information reference signal (CSI-RS) beam management procedures, in accordance with the present disclosure.

FIG. 5 is a diagram illustrating an example associated with link indication of a beam report, in accordance with the present disclosure.

FIGS. 6-8 are diagrams illustrating examples associated with estimating a channel for a backscatter device, in accordance with the present disclosure.

FIGS. 9-10 are diagrams illustrating example processes performed, for example, by a UE, in accordance with the present disclosure.

FIGS. 11-12 are diagrams illustrating example processes performed, for example, by a base station, in accordance with the present disclosure.

FIGS. 13-14 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

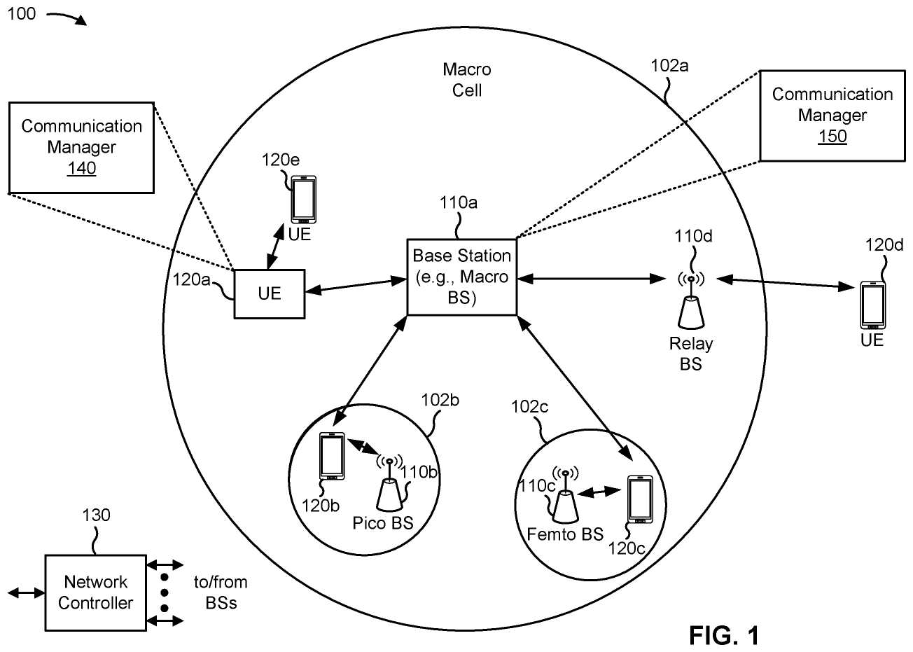

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHZ, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FRI, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a base station 110, a configuration of a beam report associated with a set of base station transmit beams, the set of base station transmit beams being directed to the UE 120 via a backscatter link reflected by a backscatter device; and transmit, to the base station, the beam report based at least in part on the configuration of the beam report, the beam report corresponding to the backscatter link. Additionally, or alternatively, the communication manager 140 may receive, from a base station 110, a configuration of an uplink transmission, wherein the UE 120 is in wireless communication with the base station 110 via a direct link and via a backscatter link reflected by a backscatter device; and transmit, to the base station 110 and based at least in part on the configuration, the uplink transmission via the direct link and via the backscatter link during a period of mandatory reflection associated with the backscatter device. Additionally, or alternatively, the communication manager 140 may perform one or more other operations described herein.

In some aspects, the base station 110 may include a communication manager 150. As described in more detail elsewhere herein, the communication manager 150 may transmit, to a UE 120, a configuration of a beam report associated with a set of base station transmit beams, the set of base station transmit beams being directed to the UE 120 via a backscatter link reflected by a backscatter device; and receive, from the UE 120, the beam report based at least in part on the configuration of the beam report, the beam report corresponding to the backscatter link. Additionally, or alternatively, the communication manager 150 may transmit, to a UE 120, a configuration of an uplink transmission, wherein the UE 120 is in wireless communication with the base station 110 via a direct link and via a backscatter link reflected by a backscatter device; transmit, to the backscatter device, a configuration of a period of mandatory reflection; and receive, from the UE 120 and based at least in part on the configuration of the uplink transmission, the uplink transmission via the direct link and via the backscatter link during the period of mandatory reflection. Additionally, or alternatively, the communication manager 150 may perform one or more other operations described herein.

As indicated above, FIG. 1 is provided as an example. Other examples may differ from what is described with regard to FIG. 1.

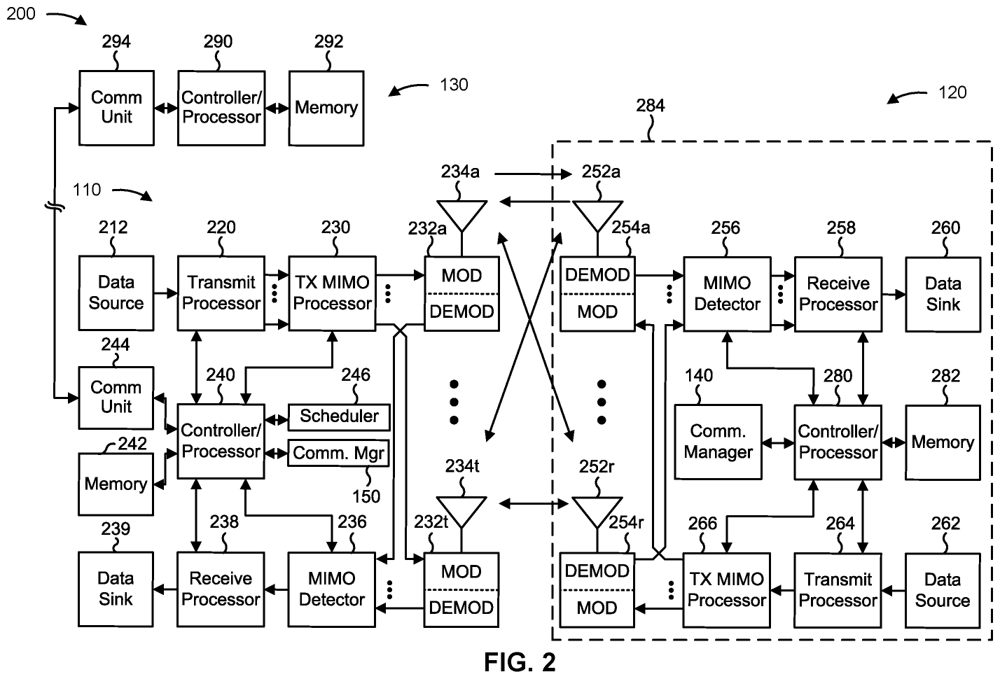

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

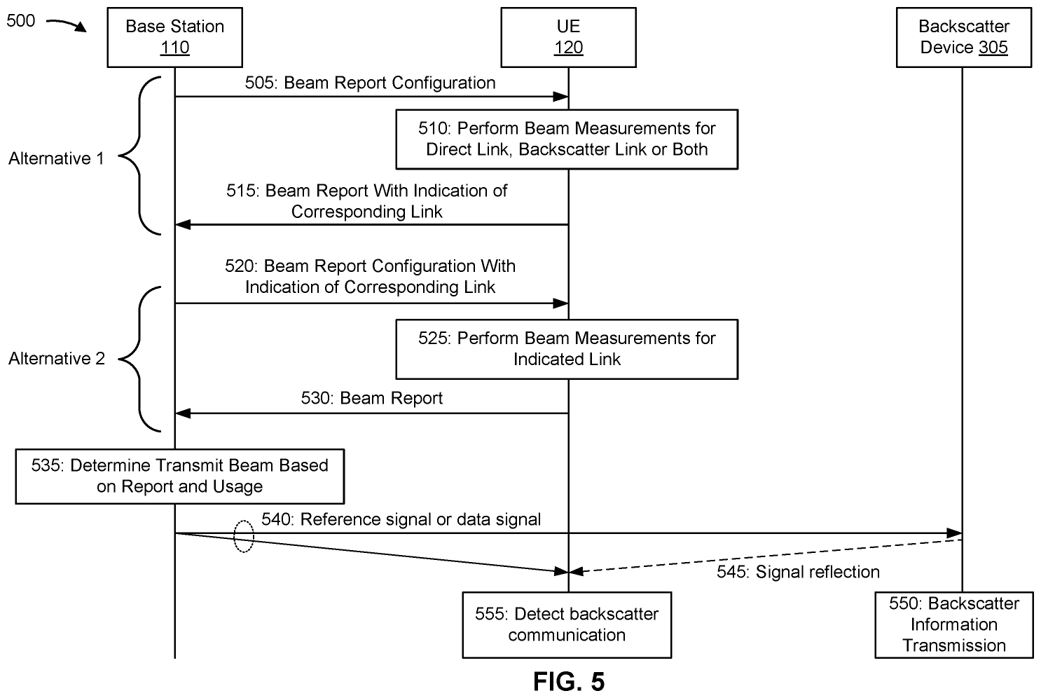

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-14).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-14).

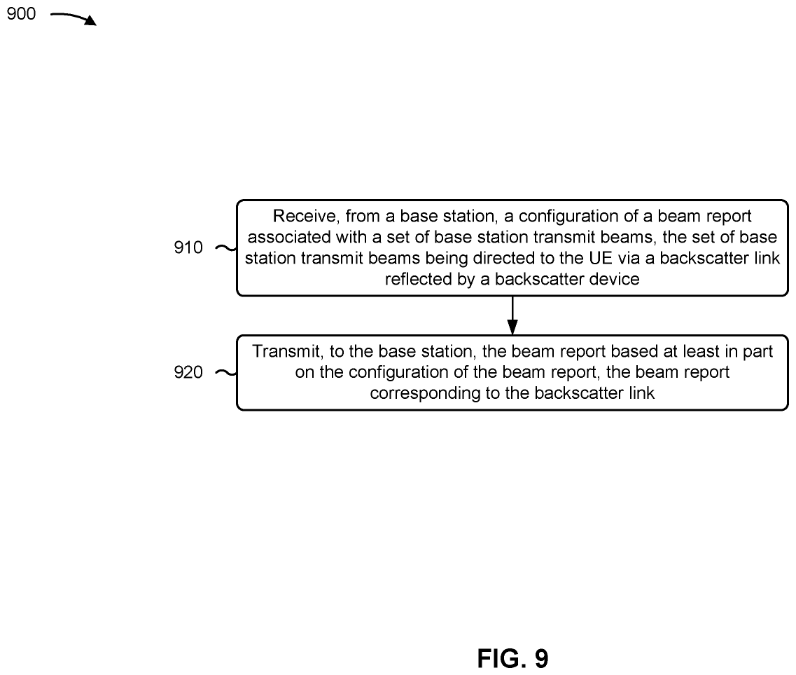

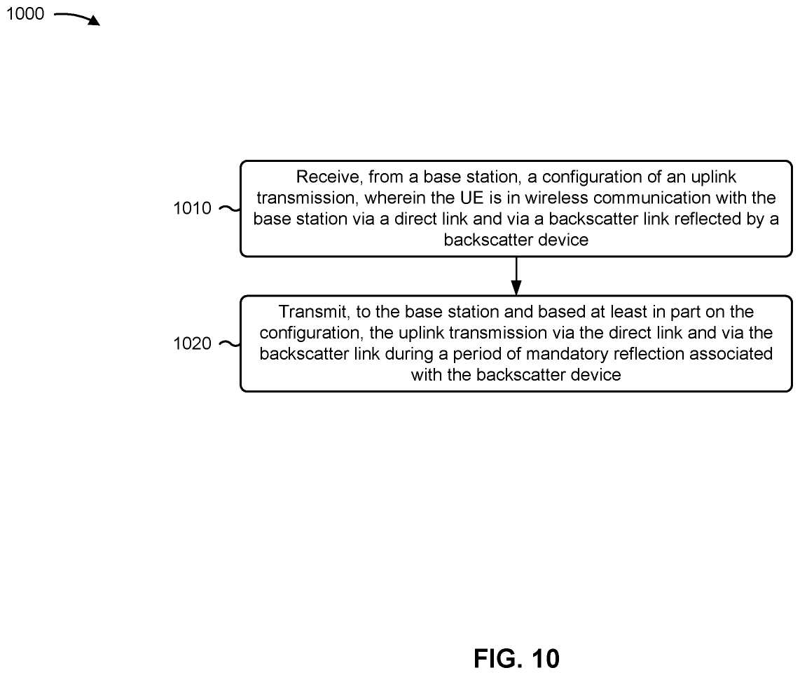

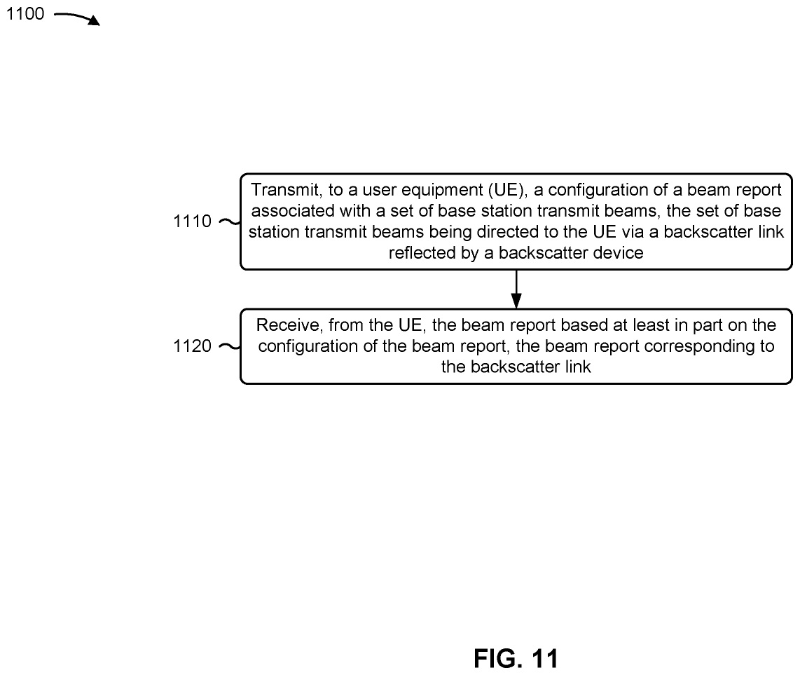

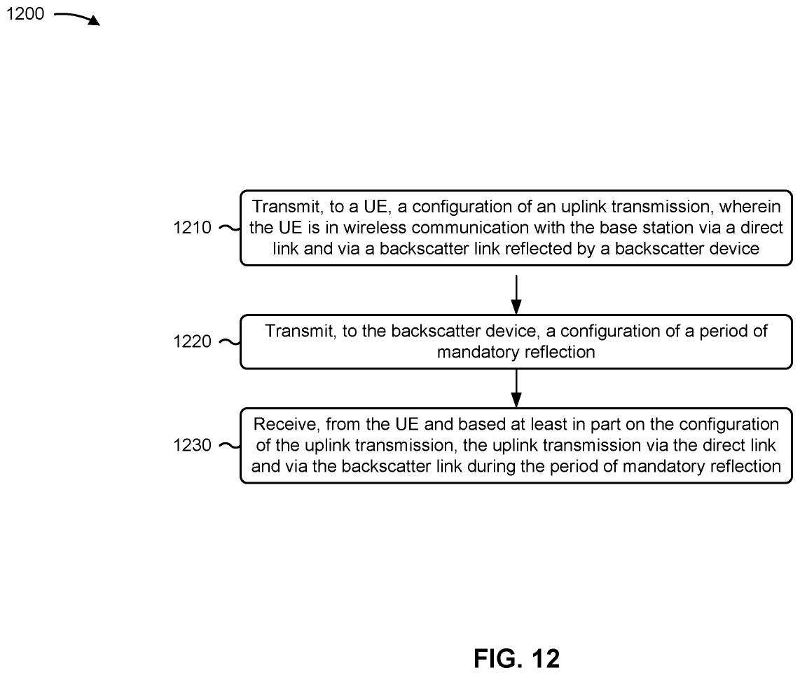

The controller/processor 240 of the base station 110, the controller/processor 280 of the UE 120, and/or any other component(s) of FIG. 2 may perform one or more techniques associated with beam determination and reporting in backscatter communication, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, process 1100 of FIG. 11, process 1200 of FIG. 12, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, a UE 120 includes means for receiving, from a base station 110, a configuration of a beam report associated with a set of base station transmit beams, the set of base station transmit beams being directed to the UE 120 via a backscatter link reflected by a backscatter device; and/or means for transmitting, to the base station 110, the beam report based at least in part on the configuration of the beam report, the beam report corresponding to the backscatter link. The means for the UE 120 to perform operations described herein (e.g., means for receiving and/or means for transmitting) may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for receiving, from a base station 110, a configuration of an uplink transmission, wherein the UE 120 is in wireless communication with the base station 110 via a direct link and via a backscatter link reflected by a backscatter device; and/or means for transmitting, to the base station 110 and based at least in part on the configuration, the uplink transmission via the direct link and via the backscatter link during a period of mandatory reflection associated with the backscatter device. The means for the UE 120 to perform operations described herein (e.g., means for receiving and/or means for transmitting) may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting, to a UE 120, a configuration of a beam report associated with a set of base station transmit beams, the set of base station transmit beams being directed to the UE 120 via a backscatter link reflected by a backscatter device; and/or means for receiving, from the UE 120, the beam report based at least in part on the configuration of the beam report, the beam report corresponding to the backscatter link. The means for the base station 110 to perform operations described herein (e.g., means for receiving and/or means for transmitting) may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the base station 110 includes means for transmitting, to a UE 120, a configuration of an uplink transmission, wherein the UE 120 is in wireless communication with the base station 110 via a direct link and via a backscatter link reflected by a backscatter device; means for transmitting, to the backscatter device, a configuration of a period of mandatory reflection; and/or means for receiving, from the UE 120 and based at least in part on the configuration of the uplink transmission, the uplink transmission via the direct link and via the backscatter link during the period of mandatory reflection. The means for the base station 110 to perform operations described herein (e.g., means for receiving and/or means for transmitting) may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

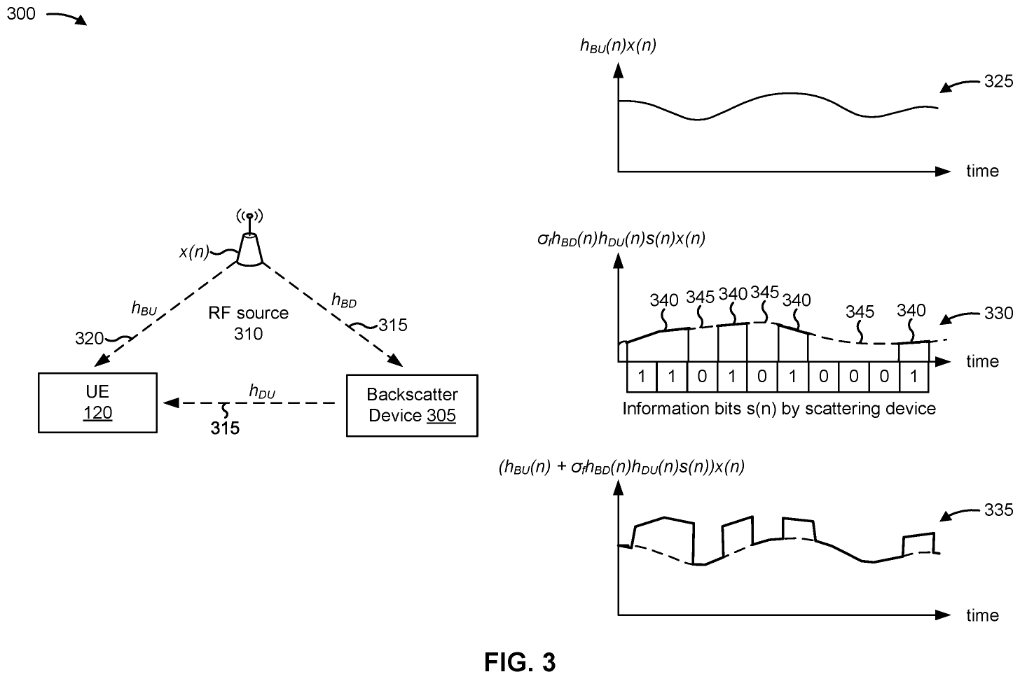

FIG. 3 is a diagram illustrating an example 300 of backscatter communication, in accordance with the present disclosure.

Some wireless communication devices may be considered as Internet-of-Things (IoT) devices. IoT technology may include passive IoT (e.g., NR passive IoT for 5G Advanced). In passive IoT, a terminal (e.g., a UE) may not include a battery, and the terminal may accumulate energy from radio signaling. Additionally, the terminal may accumulate solar energy to supplement accumulated energy from radio signaling. In passive IoT, a communication distance may be up to 30 meters (or more) to facilitate feasible network coverage over a large area (e.g., 5000 square meters), such as in a warehouse. Moreover, the power consumption of a passive IoT terminal (e.g., a UE) may be less than 0.1 milliwatts (mW) to support operation without a battery, and the terminal may be relatively inexpensive to facilitate cost-sensitive uses. A positioning accuracy of a passive IoT terminal may be approximately 3-5 meters in the horizontal and the vertical directions (e.g., for 90% of UEs).

Passive IoT may be useful in connection with industrial sensors, for which battery replacement may be prohibitively difficult or undesirable (e.g., for safety monitoring or fault detection in smart factories, infrastructures, or environments). Additionally, features of passive IoT devices, such as low cost, small size, maintenance-free, durable, long lifespan, or the like, may facilitate smart logistics/warehousing (e.g., in connection with automated asset management by replacing radio frequency identification (RFID) tags). Furthermore, passive IoT may be useful in connection with smart home networks for household item management, wearable devices (e.g., wearable devices for medical monitoring for which patients do not need to replace batteries), and/or environment monitoring. To achieve further cost reduction and zero-power communication, 5G+/6G wireless networks may utilize a type of passive IoT device referred to as an “ambient backscatter device” or a “backscatter device.”

As shown in FIG. 3, a backscatter device 305 (e.g., a tag, a sensor, or the like) may employ a simplified hardware design (e.g., including a power splitter, an energy harvester, and a microcontroller) that does not include a battery, such that the backscatter device 305 relies on energy harvesting for power, and that does not include a radio wave generation circuit, such that the backscatter device 305 is capable of transmitting information only by reflecting a radio wave. More particularly, the backscatter device 305 communicates with a reader (e.g., a UE 120 in the depicted example, but which may also be a base station 110 or another network device) by modulating a reflecting radio signal from a radio frequency (RF) source 310 (e.g., a base station 110, another UE 120, or another network device). To facilitate communication of the backscatter device 305, the RF source 310 (e.g., a base station 110) may transmit an energy harvesting wave to the backscatter device 305. Once energy is sufficiently accumulated at the backscatter device 305, the backscatter device 305 may begin to reflect the radio wave that is radiated onto the backscatter device 305 via a backscatter link 315. A channel between the RF source 310 and the backscatter device 305 of the backscatter link 315 may be associated with a first backscatter link channel response value (sometimes referred to as a first backscatter link channel coefficient or a first backscatter link gain value), h_{BD}.

As described below, the backscatter device 305 may have reflection on periods and reflection off periods that follow a pattern that is based at least in part on the transmission of information bits by the backscatter device 305. A UE 120 (e.g., a reader, a sink node, or the like) may detect the reflection pattern of the backscatter device 305 and obtain the backscatter communication information via the backscatter link 315. A channel between the UE 120 and the backscatter device 305 of the backscatter link 315 may be associated with a second backscatter link channel response value (sometimes referred to as a second backscatter link channel coefficient or a second backscatter link channel gain value), h_{DU}. In addition, the RF source 310 and the UE 120 may communicate (e.g., reference signals and/or data signals) via a direct link 320. A channel between the RF source 310 and the UE 120 of the direct link 320 may be associated with a direct link channel response value (sometimes referred to as a direct link channel coefficient or a direct link channel gain value), h_{BU}.

The backscatter device 305 may use an information modulation scheme, such as amplitude shift keying (ASK) modulation or on-off keying (OOK) modulation. For ASK or OOK modulation, the backscatter device 305 may switch on reflection when transmitting an information bit “1” and switch off reflection when transmitting an information bit “0.” In backscatter communication, the RF source 310 may transmit a particular radio wave (e.g., a reference signal or a data signal, such as a physical downlink shared channel (PDSCH)), which may be denoted as x(n). The UE 120 may receive this radio wave, x(n), directly from the RF source 310 via the direct link 320, as well as from the backscatter device 305 modulating and reflecting the radio wave to the UE 120 via the backscatter link 315. The signal received at the UE 120 via the direct link 320, denoted as h_{BU}(n)x(n) and indicated by reference number 325, is the product of the radio wave transmitted by the RF source 310, x(n), multiplied by the direct link channel response value, h_{BU}, plus any signal noise. The information bits signal of the backscatter device 305 may be denoted as s(n) where s(n)∈{0,1}. Accordingly, the signal received at the UE 120 via the backscatter link 315, denoted as σ_{f}h_{BD}(n)h_{DU}(n)s(n)x(n) and indicated by reference number 330, is the product of the signal transmitted by the RF source 310, x(n), multiplied by the first backscatter link channel response value, h_{BD}, the second backscatter link channel response value, h_{DU}, the information bits signal from the backscatter device 305, s(n), and a reflection coefficient associated with the backscatter device 305, Or, plus any noise.

Thus, the resulting signal received at the UE 120, which is the superposition of the signal received via the direct link 320 and the signal received via the backscatter link 315, may be denoted as y(n) where y(n)=(h_{BU}(n)+σ_{f}h_{BD}(n)h_{DU}(n)s(n))x(n)+noise. This signal, y(n), is shown by reference number 335. As shown, when s(n)=0 (indicated by reference number 340 in the plot shown at reference number 330), the backscatter device 305 may switch off reflection, such that the signal component σ_{f}h_{BD}(n)h_{DU}(n)s(n) equals zero, and thus the UE 120 receives only the direct link 320 signal (e.g., y(n)=h_{BU}(n)x(n)+noise). When s(n)=1 (indicated by reference number 345 in the plot shown at reference number 330), the backscatter device 305 may switch on reflection, such that signal component σ_{f}h_{BD}(n)h_{DU}(n)s(n) equals σ_{f}h_{BD}(n)h_{DU}(n), and thus the UE 120 receives a superposition of both the direct link 320 signal and the backscatter link 315 signal (e.g., y(n)=(h_{BU}(n)+σ_{f}h_{BD}(n)h_{DU}(n))x(n)+noise). To receive the information bits transmitted by the backscatter device 305, the UE 120 may first decode x(n) based at least in part on the direct link channel response value of h_{BU}(n) by treating the backscatter link 315 signal as interference. The UE 120 may then detect the existence of the signal component σ_{f}h_{BD}(n)h_{DU}(n)x(n) by subtracting h_{BU}(n)x(n) from y(n).

As indicated above, FIG. 3 is provided as an example. Other examples may differ from what is described with respect to FIG. 3.

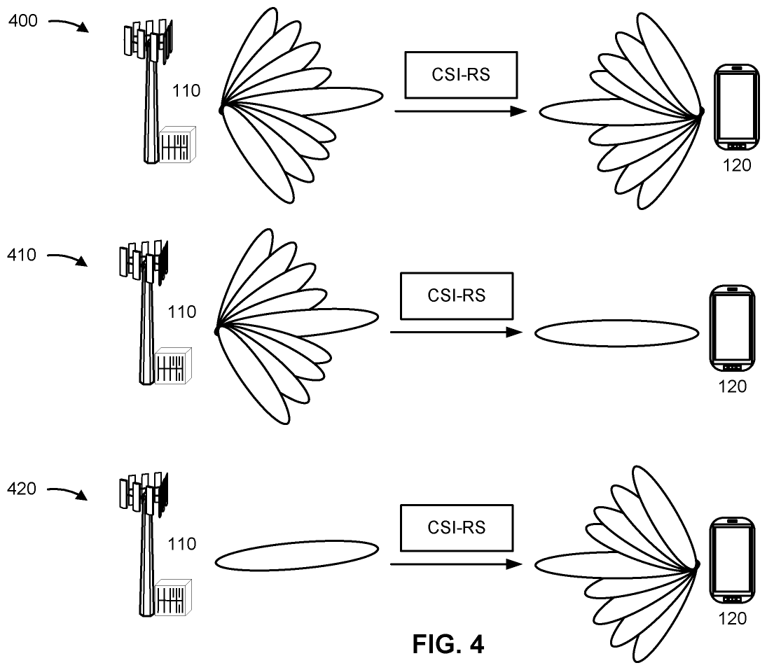

FIG. 4 is a diagram illustrating examples 400, 410, and 420 of channel station information reference signal (CSI-RS) beam management procedures, in accordance with the present disclosure. As shown in FIG. 4, examples 400, 410, and 420 include a UE 120 in communication with a base station 110 in a wireless network (e.g., wireless network 100). However, the devices shown in FIG. 4 are provided as examples, and the wireless network may support communication and beam management between other devices (e.g., between a UE 120 and a base station 110 or transmit receive point (TRP), between a mobile termination node and a control node, between an integrated access and backhaul (IAB) child node and an IAB parent node, between a scheduled node and a scheduling node, and/or between an RF source 310 and a UE 120 and/or a backscatter device 305, as described above in connection with FIG. 3). In some aspects, the UE 120 and the base station 110 may be in a connected state (e.g., a radio resource control (RRC) connected state).

In some aspects, it may be beneficial for the RF source 310 (which, may be a base station 110) to implement transmit beamforming to improve the channel gain of the backscatter link 315 and/or the direct link 320. For example, higher beamforming gain may increase the reflected signal power of the backscatter link 315. However, this requires that the base station 110 receives feedback regarding beam selection for the backscatter link 315, which the backscatter device 305, as a passive IoT device, may not be able to provide. This may be more readily understood with reference to the examples 400, 410, 420 depicted in FIG. 4, which depict typical beamforming selection procedures.

First, as shown in FIG. 4, example 400 may include a base station 110 (e.g., the RF source 310) and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the base station 110 to the UE 120. The CSI-RSs may be configured to be periodic (e.g., using RRC signaling), semi-persistent (e.g., using media access control (MAC) control element (MAC-CE) signaling), and/or aperiodic (e.g., using downlink control information (DCI)).

The first beam management procedure may include the base station 110 performing beam sweeping over multiple transmit (Tx) beams (sometimes referred to herein as multiple base station transmit beams). The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. In some aspects, the UE may report the measurements to the base station in a beam report, which may include various information related to beam selection, such as a channel status matrix, a rank indicator (RI), a precoding matrix indicator (PMI), a CSI reference signal resource indicator (CRI), one or more channel quality indicators (CQIs), or similar parameters. While example 400 has been described in connection with CSI-RSs, the first beam management process may also use synchronization signal blocks (SSBs) for beam management in a similar manner as described above.

As shown in FIG. 4, example 410 may include a base station 110 (e.g., RF source 310) and a UE 120 communicating to perform beam management using CSI-RSs. Example 410 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 4 and example 410, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams (e.g., base station transmit beams) may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120. The UE 120 may report the measurements of the CSI-RSs and other beam selection information in a beam report.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the base station 110 (e.g., RF source 310) to the UE 120. The CSI-RSs may be configured to be aperiodic (e.g., using DCI). The third beam management process may include the base station 110 transmitting the one or more CSI-RSs using a single transmit beam (e.g., a single base station transmit beam, determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

In order to improve the channel gain of the backscatter link 315, it would be desirable to use one or more of the beam management procedures described above in order to select a suitable beam for communication with the backscatter device 305. However, unlike the UE 120 depicted in examples 400, 410, and 420, a backscatter device 305 may not be able to provide feedback (e.g., information related to the backscatter link 315 beam selection) to the base station 110 (e.g., RF source 310), such as by providing a beam report and/or one or more CSI-RS measurements. As a result, beamforming traditionally could not be implemented for a backscatter link 315, resulting in reduced network efficiency as limited frequency bands are available for use for backscatter communication, reduced backscatter link 315 reliability and throughput as a transmission gain associated with the backscatter link 315 is limited, and otherwise unreliable communication to the UE 120 and/or base station 110 from the backscatter device 305.

Some techniques and apparatuses described herein enable the use of transmit beamforming to improve channel gain associated with a backscatter link 315. In some aspects, a UE 120 may estimate a channel for the backscatter link 315 and provide a beam report associated with the backscatter link 315 to the base station 110 (e.g., RF source 310). In some aspects, the UE 120 may receive a configuration of a beam report associated with one or more base station transmit beams that are directed to the UE 120 via the direct link 320 and which will be reflected to the UE 120 via the backscatter link 315, and the UE 120 may transmit a beam report in accordance with the configuration and corresponding to the backscatter link 315. In some aspects, the UE 120 may estimate the channel for the backscatter link 315 and/or select a transmit beam for the backscatter link 315 during a period of mandatory reflection, which may avoid modulation of information bits by the backscatter device 305 during the beam selection process which may otherwise interfere with the backscatter link 315 channel estimation. In some other aspects, the base station 110 may estimate the channel for the backscatter link 315 and/or select a transmit beam for the backscatter link 315 by receiving an uplink transmission from the UE 120 during the period of mandatory reflection. As a result, beamforming may be implemented for a backscatter link 315, resulting in increased network efficiency as more frequency bands are available for use for backscatter communication, increased backscatter link 315 reliability and throughput as beamformed gains may be utilized for the backscatter link 315, thus increasing a reflected signal power associated with the backscatter device 305, and overall more reliable communication to the UE 120 and/or base station 110 from the backscatter device 305.

As indicated above, FIG. 4 is provided as an example of beam management procedures. Other examples of beam management procedures may differ from what is described with respect to FIG. 4. For example, the UE 120 and the base station 110 may perform the third beam management procedure before performing the second beam management procedure, and/or the UE 120 and the base station 110 may perform a similar beam management procedure to select a UE transmit beam.

FIG. 5 is a diagram illustrating an example 500 associated with link indication of a beam report, in accordance with the present disclosure. As shown in FIG. 5, a base station 110 (e.g., an RF source 310), a UE 120, and a backscatter device 305 may communicate with one another.

In some aspects, as depicted as alternative 1 in FIG. 5, a UE 120 may perform beam selection measurements for a backscatter link 315, and provide an indication to the base station 110 that a corresponding beam report is associated with the backscatter link 315. More particularly, as shown by reference number 505, the UE 120 may receive, from the base station 110, a configuration of a beam report. In some aspects, the configuration of the beam report may be associated with a set of base station transmit beams. For example, the configuration may be associated with the base station transmit beams described above in connection with FIG. 4. The set of base station transmit beams may be beams that are directed to the UE 120 via the direct link 320 from the base station 110 and/or that are directed to the UE 120 via the backscatter link 315 reflected by the backscatter device 305. In this regard, the set of base station transmit beams may be implemented for providing beamformed gains for the transmissions using the direct link 320 and/or the backscatter link 315.

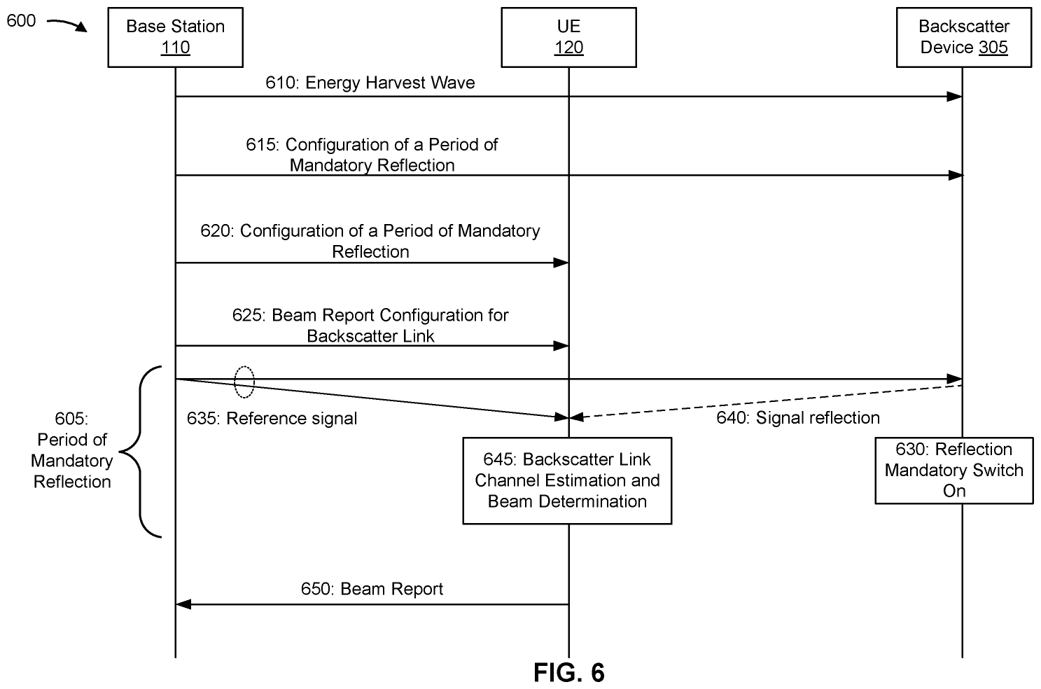

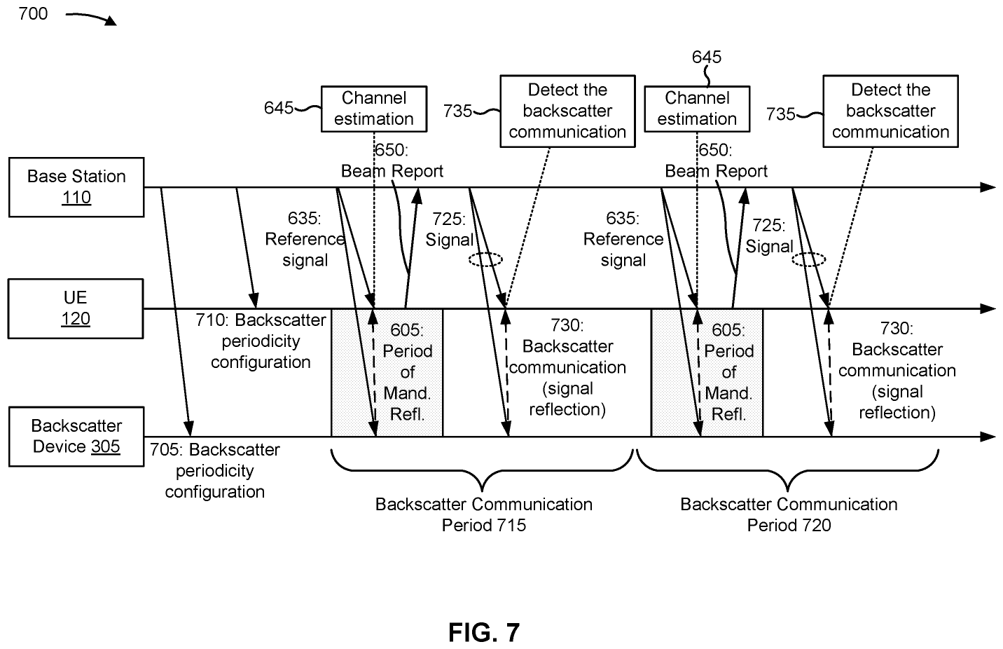

As shown by reference number 510, the UE 120 may, based at least in part on the configuration of the beam report, perform beam measurements for the direct link 320, for the backscatter link 315, or for both. For example, when performing beam measurements for the backscatter link 315, the UE 120 may measure CSI-RSs associated with the set of base station transmit beams during a period of mandatory reflection by the backscatter device 305, described in more detail below in connection with FIGS. 6-7. As shown by reference number 515, the UE 120 may provide to the base station 110 the beam report based at least in part on the configuration of the beam report. In some aspects (e.g., in alternative 1), the UE 120 may provide an indication of whether the beam report corresponds to one of the direct link 320 or the backscatter link 315. For example, when the UE 120 is performing beam measurements for the backscatter link 315, the UE 120 may provide an indication with the beam report indicating that measurements are for the backscatter link 315 and thus should be used for determining a corresponding base station transmit beam for the backscatter link 315, described more fully below in connection with reference number 535.

In some other aspects, as depicted as alternative 2 in FIG. 5, the base station 110 may provide an indication to the UE 120 indicating whether the beam report corresponds to the direct link 320 or the backscatter link 315. In this alternative, as shown by reference number 520, the configuration of the beam report transmitted from the base station 110 to the UE 120 may include an indication of the corresponding link for the beam report. Thus, and as shown by reference number 525, if the indication indicates that the beam report is for the direct link 320, the UE 120 will perform any measurements (e.g., CSI-RS measurements) and/or channel estimation on the direct link 320. And if the indication shown by reference number 520 indicates that the beam report is for the backscatter link 315, the UE 120 will perform any measurements and/or channel estimation on the backscatter link 315. The UE 120 may then report the measurements for the indicated link in a beam report, as shown by reference number

In some aspects, the base station 110 may transmit one or multiple non-precoded or precoded CSI-RSs, such as the multiple CSI-RSs described above in connection with FIG. 4, and thus, as shown at reference number 510 and/or reference number 525, the UE 120 may estimate a channel matrix (sometimes referred to as a channel status matrix) for the corresponding link via the one or multiple non-precoded or precoded CSI-RSs. For example, the UE 120 may estimate a direct link channel matrix (sometimes denoted as ĥ_{BU}) corresponding to the direct link 320, and/or the UE 120 may estimate a backscatter link channel matrix (sometimes denoted as ĥₛ, which is equal to ĥ_{BD}ĥ_{DU}) corresponding to the backscatter link 315. If a set of precoded CSI-RSs are transmitted using a beam sweep, the UE 120 may estimate and store the channel status of each beam (e.g., ĥ_{BU,i} and/or ĥ_{s,i}). Moreover, if a power level of the signal received on the direct link 320 is near a power level of the signal received on the backscatter link 315, the base station 110 may configure a period to suspend reflection associated with the backscatter device 305, and the UE 120 may estimate the direct link channel matrix (e.g., ĥ_{BU} or ĥ_{BU,i}) during the period to suspend reflection. In this way, the UE 120 may estimate the direct link channel matrix (e.g., ĥ_{BU} or ĥ_{BU,i}) based at least in part on the reference signal received via the direct link 320 without interference from a signal received from the backscatter link 315.

In some aspects, the UE 120 may estimate the backscatter link channel matrix (e.g., ĥₛ or ĥ_{s,i}) based at least in part on the direct link channel matrix (e.g., ĥ_{BU} or ĥ_{BU,i}). For example, in some aspects, the base station 110 may configure a period of mandatory reflection associated with the backscatter device 305, during which reflection by the backscatter device 305 remains on (e.g., during the period of mandatory reflection, the backscatter device 305 transmits only information bit “1”). The period of mandatory reflection is described more fully below in connection with FIGS. 6-8. In some aspects, the UE 120 may estimate the backscatter link channel matrix (e.g., ĥₛ) during the period of mandatory reflection as

$$\frac{y}{x} - {\hat{h}}_{BU} .$$

Moreover, in some aspects, the base station 110 may transmit repeat transmissions of the multiple CSI-RSs based at least in part on a signal-to-noise ratio (SNR) of the backscatter link 315 satisfying a SNR threshold.

In aspects in which a precoded CSI-RS is used, identical beams may be used both when the UE 120 is estimating the direct link channel matrix (e.g., ĥ_{BU} or ĥ_{BU,i}) and when the UE 120 is estimating the backscatter link channel matrix (e.g., ĥₛ or ĥ_{s,i}) More particularly, the UE 120 may receive multiple beam sweeps, each including identical base station transmit beams, and the UE 120 may estimate the direct link channel matrix based at least in part on a first beam sweep (e.g., a beam sweep transmitted during the period to suspend reflection), and may estimate the backscatter link channel matrix based at least in part on a second beam sweep (e.g., a beam sweep transmitted during the period of mandatory reflection). In some aspects, the base station 110 may indicate to the UE 120 an association between the two beam sweeps, such as by indicating that each pair of corresponding CSI-RS resources in the two beam sweeps are transmitted within identical beams. Additionally, or alternatively, the base station transmit beams of the first beam sweep may be quasi co-located (QCL) with corresponding base station transmit beams of the second beam sweep. Accordingly, in such aspects, a position of each of the base station transmit beams in the first beam sweep is the same as a position of the corresponding base station transmit beam in the second beam sweep. After receiving the multiple beam sweeps, for each base station transmit beam, i, in the beam sweep, the UE 120 may estimate the backscatter channel matrix, ĥ_{s,i}, as

$$\frac{y}{x} - {\hat{h}}_{BU , i} .$$

As shown by reference number 535, once the base station 110 receives the beam report (which may include the channel estimation as described above), the base station 110 may determine a base station transmit beam for transmitting communications on the direct link and/or the backscatter link 315. In some aspects, the base station 110 may determine a base station transmit beam (e.g., a base station transmit beam to be used during subsequent communications) for the direct link 320 and/or the backscatter link 315 based at least in part on the beam report and a usage of the one or more base station transmit beams for communicating with other UEs or other network devices. In some other aspects, the UE 120 may determine a corresponding transmit beam (e.g., a base station transmit beam to be used during subsequent communications) for the direct link 320 and/or the backscatter link 315, and include the determination of the base station transmit beams in the beam report indicated by reference numbers 515 or 530.

In some aspects, the determined base station transmit beam may be the same for the direct link 320 and the backscatter link 315, while in other aspects the determined base station transmit beam may differ between the links. More particularly, in aspects in which non-precoded CSI-RS is transmitted by the base station 110, the base station 110 and/or the UE 120 may determine a corresponding base station transmit beam based at least in part on a combined beamformed channel gain, based at least in part on a channel gain of the direct link 320, and/or based at least in part on a channel gain of the backscatter link 315. For example, in aspects in which non-precoded CSI-RS is transmitted, the generated beamforming weight (sometimes denoted as w) may be selected to maximize a function related to the direct link channel matrix (e.g., ĥ_{BU}) and the backscatter link channel matrix (e.g., ĥₛ). Put another way, the generated beamforming weight (e.g., w) may be selected to maximize the combined beamformed channel gain. In some aspects, the generated beamforming weight (e.g., w) is selected to maximize at least one of ∥(ĥ_{BU}+ĥₛ)w∥₂² or α∥h_{BU}w∥₂²+β∥ĥₛw∥₂², where α and β are prioritization coefficients associated with the direct link 320 and the backscatter link 315, respectively. For example, when determining a transmit beam to be used for the direct link 320, the base station 110 and/or the UE 120 may utilize prioritization coefficients α=1 and β=0. When determining a transmit beam to be used for the backscatter link 315, the base station 110 and/or the UE 120 may utilize prioritization coefficients α=0 and β=1. And when determining a transmit beam to be used for both the direct link 320 and the backscatter link 315, the base station 110 and/or the UE 120 may utilize prioritization coefficients that are the same or different depending on the prioritization of each respective channel (e.g., a may be larger when the direct link 320 has a greater priority, while β may be larger when the backscatter link 315 has a greater priority). In aspects in which precoded CSI-RS is transmitted, the UE 120 and/or the base station 110 may select a base station transmit beam that has the largest channel gain for the direct link 320, the backscatter link 315, or both links.

In some aspects, the beam report transmitted by the UE 120 to the base station 110, as indicated by either reference number 515 or reference number 530, may include various additional measurements and other parameters relating to the channel state of the respective links (e.g., related to the channel state of the link of the corresponding one of the direct link 320 and/or the backscatter link 315 to which the beam report pertains). For example, in aspects in which non-precoded CSI-RS is utilized, the beam report may include an RI, a PMI, or a similar parameter. And in aspects in which precoded CSI-RS is utilized, the beam report may include a CRI or a similar parameter. Moreover, the beam report may include one or more CQIs for each transmit beam. For example, the beam report may report a pair of CQIs for each base station transmit beam, wherein a first CQI of the pair of CQIs is associated with a transmission with the backscatter device 305 being activated, and wherein a second CQI of the pair of CQIs is associated with a transmission with the backscatter device 305 being deactivated. In some aspects, one or more of the channel quality parameters (e.g., RI, PMI, CRI, CQI, or a similar parameter) may be derived from one or more of h_{BU}, ĥₛ, or w.

Once the corresponding transmit beams have been determined for the direct link 320 and the backscatter link 315, the base station 110 may transmit a communication (e.g., a reference signal, a data signal, or a similar signal) via the direct link 320 and the backscatter link 315 using the respective transmit beams, as shown by reference number 540. More particularly, the transmission indicated by reference number 540 is directly transmitted to the UE 120 on the direct link 320 and is reflected to the UE 120, as shown by reference number 545, via the backscatter device 305. As shown by reference number 550, the backscatter device 305 may transmit information to the UE 120 via the signal reflection (as shown by reference number 545) by modulating and reflecting the signal shown by reference number 540. The backscatter device 305 may modulate the signal by switching on reflection when transmitting an information bit “1” and switching off reflection when transmitting an information bit “0.” As shown by reference number 555, the UE 120 may detect the backscatter communication and determine the backscatter information transmission by subtracting the signal received via the direct link 320 from the aggregate signal received from both the direct link 320 and the backscatter link 315, as described above in connection with FIG. 3. Thus, by receiving or providing an indication of the corresponding link for a beam report, the UE 120 can perform measurements on the backscatter link 315 channel and/or estimate the backscatter link 315 channel on behalf of the backscatter device 305, beneficially allowing for the use of beamforming techniques when communicating via a backscatter link 315.

As indicated above, FIG. 5 is provided as an example. Other examples may differ from what is described with respect to FIG. 5.

FIG. 6 is a diagram illustrating an example 600 associated with estimating a channel for a backscatter device, in accordance with the present disclosure. As shown in FIG. 6, a base station 110 (e.g., an RF source 310), a UE 120, and a backscatter device 305 may communicate with one another.

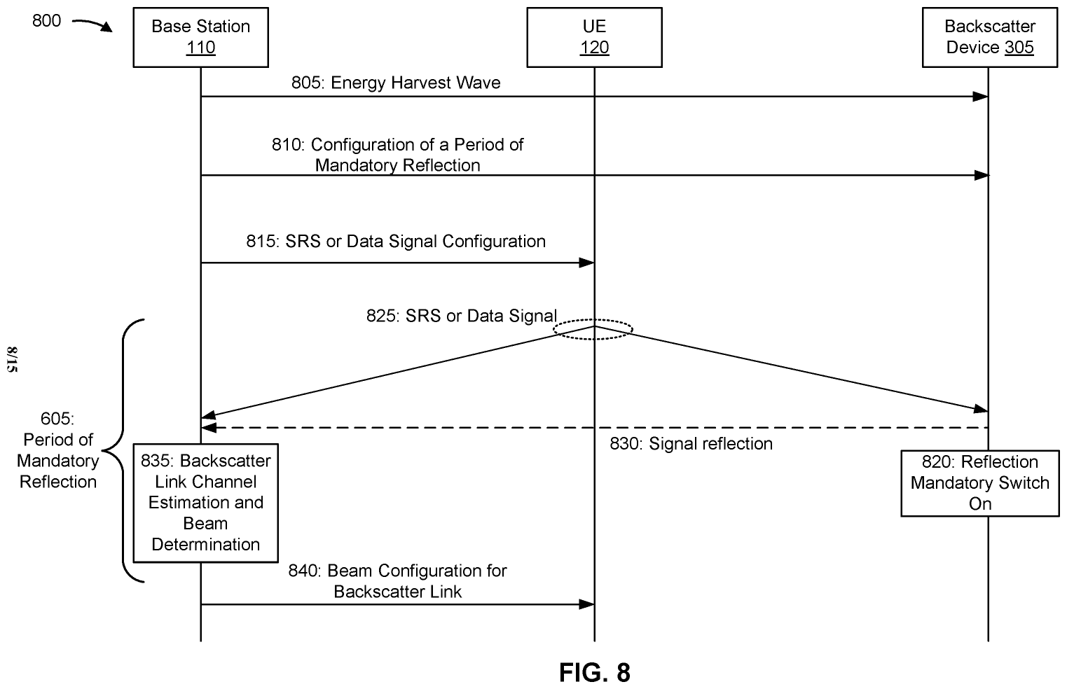

In some aspects, the UE 120 and/or the base station 110 may estimate a channel (e.g., the backscatter link channel) during a period of mandatory reflection 605 by the backscatter device 305. In the example shown in FIG. 6, the UE 120 estimates the backscatter link channel during the period of mandatory reflection 605, but in some other aspects, another network device may estimate the backscatter link channel during the period of mandatory reflection, as described below in connection with FIG. 8. As shown by reference number 610, the base station 110 (or other RF source 310) may transmit an energy harvest wave to the backscatter device 305, as described above in connection with FIG. 3. As shown by reference numbers 615 and 620, the base station 110 may also transmit to the backscatter device 305 and the UE 120, respectively, a configuration of the period of mandatory reflection 605. In some aspects, the configuration of the period of mandatory reflection 605 may indicate a start position of the period of mandatory reflection 605 and a length of the period of mandatory reflection 605. Moreover, in some aspects, the configuration of the period of mandatory reflection 605 may indicate a periodicity of the period of mandatory reflection 605, such that the backscatter device 305 periodically repeats the period of mandatory reflection 605. In aspects in which the backscatter device uses ASK or OOK modulation to transmit information, the configuration of the period of mandatory reflection 605 may indicate to the backscatter device 305 that the backscatter device 305 should transmit a sequence of all one bits (e.g., bits “11 . . . 1”) during the period of mandatory reflection 605. The configuration of the period of mandatory reflection 605 transmitted to the UE 120, as indicated by reference number 620, may be provided in the same communication as the configuration of the period of mandatory reflection 605 transmitted to the backscatter device 305, as indicated by reference number 615, or else may be provided in a separate communication specifically directed to the UE 120.

As shown by reference number 625, the base station 110 may transmit to the UE 120 a configuration of a beam report associated with the backscatter link 315, which may be similar to the configurations described above in connection with reference numbers 505 and 520. Moreover, as shown by reference number 630, the backscatter device 305 may switch on reflection (e.g., may transmit information in all one bits) in accordance with the configuration of the period of mandatory reflection 605. While the backscatter device 305 is always reflecting the signal from the base station (e.g., while the backscatter device transmits information in all one bits during the period of mandatory reflection 605), the base station 110 may transmit a reference signal to the UE 120 and the backscatter device 305, as shown by reference number 635. The backscatter device 305 thus reflects the reference signal to the UE 120, as indicated by reference number 640, without modulating the reference signal because the backscatter device is only transmitting in information bit 1 during this period. As shown by reference number 645, the UE 120 may then estimate the backscatter link channel and/or determine a transmit beam associated with the backscatter link 315, as described above in connection with FIG. 5. As shown by reference number 650, the UE 120 may provide a beam report to the base station 110 including indications of the backscatter link channel estimation and/or beam selection for the backscatter link 315, as described above in connection with reference number 530.

As indicated above, FIG. 6 is provided as an example. Other examples may differ from what is described with respect to FIG. 6.

FIG. 7 is a diagram illustrating an example 700 associated with estimating a channel for a backscatter device, in accordance with the present disclosure. As shown in FIG. 7, a base station 110 (e.g., an RF source 310), a UE 120, and a backscatter device 305 may communicate with one another.

In the example depicted in FIG. 7, the period of mandatory reflection 605 repeats according to a periodicity. In some aspects, the periodicity may be provided in the configuration of the period of mandatory reflection indicated by reference numbers 615 and 620. Additionally, or alternatively, the base station may provide to the backscatter device 305 and the UE 120 a backscatter periodicity configuration, as indicated by reference numbers 705 and 710, respectively. In some aspects, the backscatter periodicity configuration indicated by reference numbers 705 and 710 may include additional parameters such as the start position of the period of mandatory reflection and the length of the period of mandatory reflection. The backscatter periodicity configuration may indicate that the period of mandatory reflection 605 should repeat once every backscatter communication period. For example, a first instance of the period of mandatory reflection 605 may occur in a first backscatter communication period 715, a second instance of the period of mandatory reflection 605 may occur in a second backscatter communication period 720, and so forth. Accordingly, the UE 120 may estimate the backscatter link channel, as indicated by reference number 645, and provide a corresponding beam report for the backscatter device 305, as indicated by reference number 650, once per backscatter communication period 715, 720. Moreover, in some aspects, the UE 120 and/or the backscatter device 305 may receive additional signals within each backscatter communication period 715, 720. For example, as shown by reference numbers 725 and 730, the UE 120 may receive transmissions on the direct link 320 and the backscatter link 315, respectively, as described above in connection with reference number 540 and 545. Moreover, as shown by reference number 735, the UE 120 may detect the backscatter communication, as described above in connection with reference number 555.

As indicated above, FIG. 7 is provided as an example. Other examples may differ from what is described with respect to FIG. 7.

FIG. 8 is a diagram illustrating an example 800 associated with estimating a channel for a backscatter device, in accordance with the present disclosure. As shown in FIG. 8, a base station 110 (e.g., an RF source 310), a UE 120, and a backscatter device 305 may communicate with one another.

In the example shown in FIG. 8, the base station 110 may estimate the backscatter link channel during the period of mandatory reflection 605. As shown by reference number 805, the base station 110 (or other RF source 310) may transmit an energy harvest wave to the backscatter device 305, as described above in connection with FIG. 3. As shown by reference number 810, the base station 110 may also transmit to the backscatter device 305 a configuration of a period of mandatory reflection 605. As described above in connection with FIGS. 6 and 7, in some aspects, the configuration of the period of mandatory reflection 605 may indicate a start position of the period of mandatory reflection 605, a length of the period of mandatory reflection 605, and/or a periodicity of the period of mandatory reflection 605. In aspects in which the backscatter device uses ASK or OOK modulation to transmit information, the configuration of the period of mandatory reflection 605 may indicate to the backscatter device 305 that the backscatter device should transmit a sequence of all one bits (e.g., bits “11 . . . 1”) during the period of mandatory reflection 605.

As shown by reference number 815, the base station 110 may transmit to the UE 120 a sounding reference signal (SRS) and/or a data signal configuration. The SRS and/or the data signal configuration may indicate to the UE 120 to transmit an SRS and/or data signal during the period of mandatory reflection 605, such that the base station 110 may perform backscatter link channel estimation and/or backscatter link beam determination based at least in part on the SRS and/or data signal.

As shown by reference number 820, the backscatter device 305 may switch on reflection (e.g., may transmit information in all one bits) in accordance with the configuration of the period of mandatory reflection 605. While the backscatter device 305 is always reflecting the signal from the base station (e.g., while the backscatter device transmits information in all one bits during the period of mandatory reflection 605), the UE 120 may transmit an SRS and/or data signal to the base station 110 and the backscatter device 305, as shown by reference number 825. The backscatter device 305 thus reflects the SRS and/or data signal (as shown by reference number 825) to the base station 110, as indicated by reference number 830, without modulating the SRS and/or data signal because the backscatter device 305 is transmitting in only information bit “1” during the period of mandatory reflection 605. As shown by reference number 835, the base station 110 may then estimate the backscatter link channel and/or determine a transmit beam associated with the backscatter link 315, as described above in connection with FIG. 5. As shown by reference number 840, the base station 110 may provide a beam configuration for the backscatter link 315 to the UE 120, such that the UE 120 may use the determined transmit beam for transmitting subsequent signals using the backscatter link 315.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with beam determination and reporting in backscatter communication.

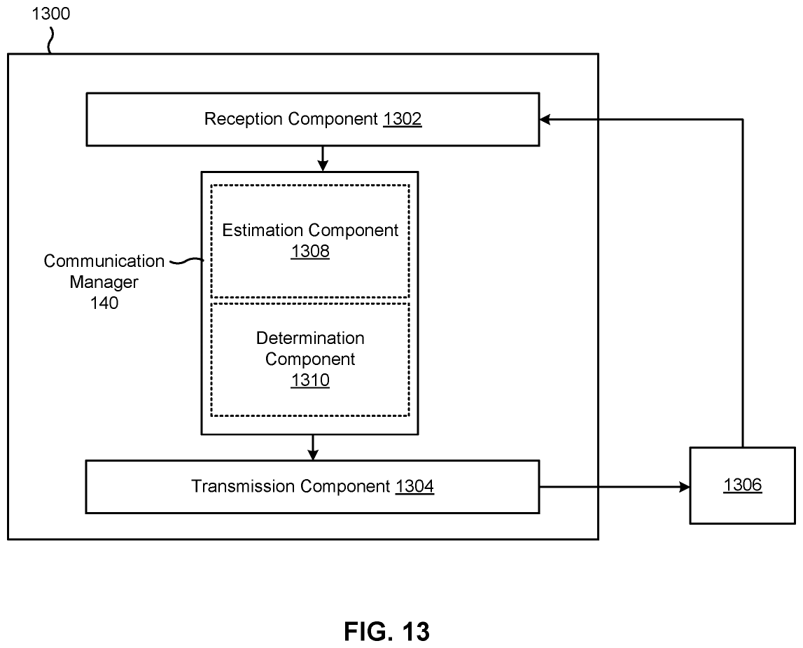

As shown in FIG. 9, in some aspects, process 900 may include receiving, from a base station, a configuration of a beam report associated with a set of base station transmit beams, the set of base station transmit beams being directed to the UE via a backscatter link reflected by a backscatter device (block 910). For example, the UE (e.g., using communication manager 140 and/or reception component 1302, depicted in FIG. 13) may receive, from a base station, a configuration of a beam report associated with a set of base station transmit beams, the set of base station transmit beams being directed to the UE via a backscatter link reflected by a backscatter device, as described above.

As further shown in FIG. 9, in some aspects, process 900 may include transmitting, to the base station, the beam report based at least in part on the configuration of the beam report, the beam report corresponding to the backscatter link (block 920). For example, the UE (e.g., using communication manager 140 and/or transmission component 1304, depicted in FIG. 13) may transmit, to the base station, the beam report based at least in part on the configuration of the beam report, the beam report corresponding to the backscatter link, as described above.

Process 900 may include additional aspects, such as any single aspect or any combination of aspects described below and/or in connection with one or more other processes described elsewhere herein.

In a first aspect, process 900 includes transmitting, to the base station, an indication of whether the beam report corresponds to a direct link between the base station and the UE or to the backscatter link.

In a second aspect, alone or in combination with the first aspect, process 900 includes receiving, from the base station, an indication of whether the beam report corresponds to a direct link between the base station and the UE or to the backscatter link.

In a third aspect, alone or in combination with one or more of the first and second aspects, process 900 includes receiving, from the base station, a transmission on a first base station transmit beam of the set of base station transmit beams based at least in part on the beam report, wherein the transmission is received via the backscatter link.

In a fourth aspect, alone or in combination with one or more of the first through third aspects, process 900 includes receiving, from the base station, multiple base station transmit beams including multiple CSI-RSs, wherein each base station transmit beam of the multiple base station transmit beams includes a corresponding CSI-RS, and estimating a direct link channel matrix based at least in part on the multiple CSI-RSs.

In a fifth aspect, alone or in combination with one or more of the first through fourth aspects, process 900 includes receiving, from the base station, a configuration of a period to suspend reflection associated with the backscatter device, wherein estimating the direct link channel matrix is performed during the period to suspend reflection.

In a sixth aspect, alone or in combination with one or more of the first through fifth aspects, process 900 includes estimating a corresponding direct link channel for each base station transmit beam of the multiple base station transmit beams based at least in part on the corresponding CSI-RS.

In a seventh aspect, alone or in combination with one or more of the first through sixth aspects, the beam report indicates at least one of an RI, a PMI, or a CRI associated with each CSI-RS.

In an eighth aspect, alone or in combination with one or more of the first through seventh aspects, the beam report includes a pair of CQIs for each of the multiple base station transmit beams, wherein a first CQI of the pair of CQIs is associated with a transmission with a reflection of the backscatter device being activated, and wherein a second CQI of the pair of CQIs is associated with a transmission with the reflection of the backscatter device being deactivated.

In a ninth aspect, alone or in combination with one or more of the first through eighth aspects, process 900 includes estimating a backscatter link channel matrix based at least in part on the direct link channel matrix.

In a tenth aspect, alone or in combination with one or more of the first through ninth aspects, process 900 includes receiving, from the base station, one or more repeat transmissions of the multiple CSI-RSs based at least in part on an SNR of the backscatter link satisfying a SNR threshold.

In an eleventh aspect, alone or in combination with one or more of the first through tenth aspects, process 900 includes receiving, from the base station, multiple beam sweeps, wherein each beam sweep of the multiple beam sweeps includes the multiple base station transmit beams, estimating the direct link channel matrix based at least in part on a first beam sweep of the multiple beam sweeps, and estimating the backscatter link channel matrix based at least in part on a second beam sweep of the multiple beam sweeps.

In a twelfth aspect, alone or in combination with one or more of the first through eleventh aspects, the base station transmit beams of the first beam sweep are QCL with corresponding base station transmit beams of the second beam sweep, and a position of each of the base station transmit beams in the first beam sweep is the same as a position of the corresponding base station transmit beam in the second beam sweep.

In a thirteenth aspect, alone or in combination with one or more of the first through twelfth aspects, process 900 includes determining a first base station transmit beam for the direct link based at least in part on the direct link channel matrix, and determining a second base station transmit beam for the backscatter link based at least in part on the backscatter link channel matrix.

In a fourteenth aspect, alone or in combination with one or more of the first through thirteenth aspects, the first base station transmit beam and the second base station transmit beam are determined based at least in part on determining a combined beamformed channel gain.

In a fifteenth aspect, alone or in combination with one or more of the first through fourteenth aspects, the first base station transmit beam is the same as the second base station transmit beam.

In a sixteenth aspect, alone or in combination with one or more of the first through fifteenth aspects, the first base station transmit beam is different than the second base station transmit beam.

In a seventeenth aspect, alone or in combination with one or more of the first through sixteenth aspects, the first base station transmit beam and the second base station transmit beam are determined based at least in part on a channel gain associated with at least one of the direct link or the backscatter link.

In an eighteenth aspect, alone or in combination with one or more of the first through seventeenth aspects, process 900 includes receiving, from the base station, a configuration of a period of mandatory reflection associated with the backscatter device, wherein estimating the backscatter link channel matrix is performed during the period of mandatory reflection.

In a nineteenth aspect, alone or in combination with one or more of the first through eighteenth aspects, the configuration of the period of mandatory reflection indicates a start position of the period of mandatory reflection and a length of the period of mandatory reflection.

In a twentieth aspect, alone or in combination with one or more of the first through nineteenth aspects, the configuration of the period of mandatory reflection indicates a periodicity of mandatory reflection.

In a twenty-first aspect, alone or in combination with one or more of the first through twentieth aspects, during the period of mandatory reflection, the UE receives a transmission of a sequence of all one bits from the backscatter device.

In a twenty-second aspect, alone or in combination with one or more of the first through twenty-first aspects, process 900 includes receiving a transmission via the backscatter link, wherein the backscatter device reflects the transmission to the UE by turning on reflection when transmitting an information bit 1 and by turning off reflection when transmitting an information bit 0.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 120) performs operations associated with beam determination and reporting in backscatter communication.

As shown in FIG. 10, in some aspects, process 1000 may include receiving, from a base station, a configuration of an uplink transmission, wherein the UE is in wireless communication with the base station via a direct link and via a backscatter link reflected by a backscatter device (block 1010). For example, the UE (e.g., using communication manager 140 and/or reception component 1302, depicted in FIG. 13) may receive, from a base station, a configuration of an uplink transmission, wherein the UE is in wireless communication with the base station via a direct link and via a backscatter link reflected by a backscatter device, as described above.

As further shown in FIG. 10, in some aspects, process 1000 may include transmitting, to the base station and based at least in part on the configuration, the uplink transmission via the direct link and via the backscatter link during a period of mandatory reflection associated with the backscatter device (block 1020). For example, the UE (e.g., using communication manager 140 and/or transmission component 1304, depicted in FIG. 13) may transmit, to the base station and based at least in part on the configuration, the uplink transmission via the direct link and via the backscatter link during a period of mandatory reflection associated with the backscatter device, as described above.

Process 1000 may include additional aspects, such as any single aspect or any combination of aspects described below and/or in connection with one or more other processes described elsewhere herein.

In one aspect, process 1000 includes receiving, from the base station, a configuration of a transmit beam associated with the backscatter link based at least in part on a measurement associated with the backscatter link during the period of mandatory reflection.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a base station, in accordance with the present disclosure. Example process 1100 is an example where the base station (e.g., base station 110) performs operations associated with beam determination and reporting in backscatter communication.

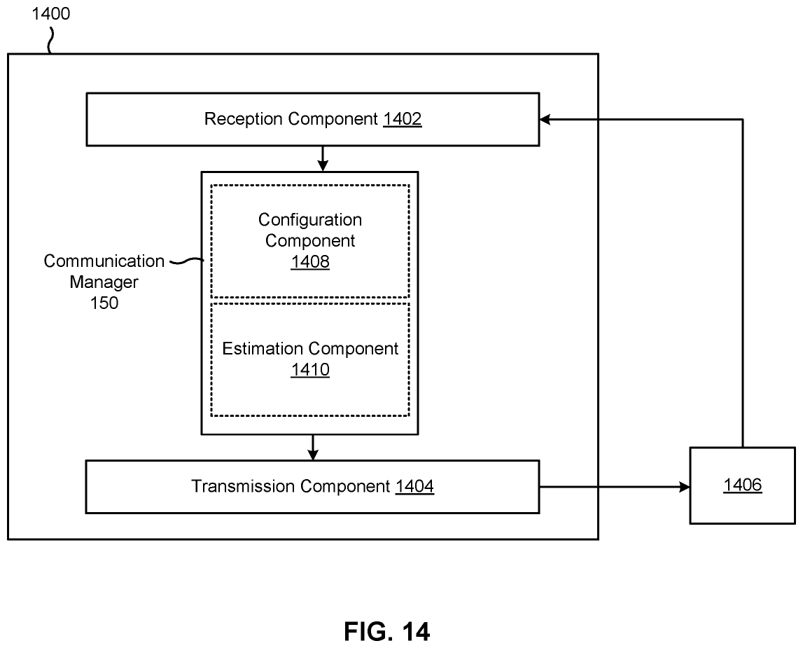

As shown in FIG. 11, in some aspects, process 1100 may include transmitting, to a UE, a configuration of a beam report associated with a set of base station transmit beams, the set of base station transmit beams being directed to the UE via a backscatter link reflected by a backscatter device (block 1110). For example, the base station (e.g., using communication manager 150 and/or transmission component 1404, depicted in FIG. 14) may transmit, to a UE, a configuration of a beam report associated with a set of base station transmit beams, the set of base station transmit beams being directed to the UE via a backscatter link reflected by a backscatter device, as described above.

As further shown in FIG. 11, in some aspects, process 1100 may include receiving, from the UE, the beam report based at least in part on the configuration of the beam report, the beam report corresponding to the backscatter link (block 1120). For example, the base station (e.g., using communication manager 150 and/or reception component 1402, depicted in FIG. 14) may receive, from the UE, the beam report based at least in part on the configuration of the beam report, the beam report corresponding to the backscatter link, as described above.

Process 1100 may include additional aspects, such as any single aspect or any combination of aspects described below and/or in connection with one or more other processes described elsewhere herein.

In a first aspect, process 1100 includes receiving, from the UE, an indication of whether the beam report corresponds to a direct link between the base station and the UE or to the backscatter link.

In a second aspect, alone or in combination with the first aspect, process 1100 includes transmitting, to the UE, an indication of whether the beam report corresponds to a direct link between the base station and the UE or to the backscatter link.

In a third aspect, alone or in combination with one or more of the first and second aspects, process 1100 includes transmitting, to the UE, a transmission on a first base station transmit beam of the set of base station transmit beams based at least in part on the beam report, wherein the transmission is transmitted via the backscatter link.

In a fourth aspect, alone or in combination with one or more of the first through third aspects, process 1100 includes transmitting, to the UE, multiple base station transmit beams including multiple CSI-RSs, wherein each base station transmit beam of the multiple base station transmit beams includes a corresponding CSI-RS, and receiving, from the UE, an estimation of a direct link channel matrix based at least in part on the multiple CSI-RSs.

In a fifth aspect, alone or in combination with one or more of the first through fourth aspects, process 1100 includes transmitting, to the UE, a configuration of a period to suspend reflection associated with the backscatter device, wherein the UE estimates the direct link channel matrix during the period to suspend reflection.

In a sixth aspect, alone or in combination with one or more of the first through fifth aspects, process 1100 includes receiving, from the UE, an estimation of a corresponding direct link channel for each base station transmit beam of the multiple base station transmit beams based at least in part on the corresponding CSI-RS.

In a seventh aspect, alone or in combination with one or more of the first through sixth aspects, the beam report indicates at least one of an RI, a PMI, or a CRI associated with each CSI-RS.

In an eighth aspect, alone or in combination with one or more of the first through seventh aspects, the beam report includes a pair of CQIs for each of the multiple base station transmit beams, wherein a first CQI of the pair of CQIs is associated with a transmission with a reflection of the backscatter device being activated, and a second CQI of the pair of CQIs is associated with a transmission with the reflection of the backscatter device being deactivated.

In a ninth aspect, alone or in combination with one or more of the first through eighth aspects, process 1100 includes receiving, from the UE, an estimation of a backscatter link channel matrix based at least in part on the direct link channel matrix.

In a tenth aspect, alone or in combination with one or more of the first through ninth aspects, process 1100 includes transmitting, to the UE, one or more repeat transmissions of the multiple CSI-RSs based at least in part on an SNR of the backscatter link satisfying a SNR threshold.

In an eleventh aspect, alone or in combination with one or more of the first through tenth aspects, process 1100 includes transmitting, to the UE, multiple beam sweeps, wherein each beam sweep of the multiple beam sweeps includes the multiple base station transmit beams, receiving, from the UE, the estimation of the direct link channel matrix based at least in part on a first beam sweep of the multiple beam sweeps, and receiving, from the UE, the estimation of the backscatter link channel matrix based at least in part on a second beam sweep of the multiple beam sweeps.

In a twelfth aspect, alone or in combination with one or more of the first through eleventh aspects, the base station transmit beams of the first beam sweep are QCL with corresponding base station transmit beams of the second beam sweep, and a position of each of the base station transmit beams in the first beam sweep is the same as a position of the corresponding base station transmit beam in the second beam sweep.

In a thirteenth aspect, alone or in combination with one or more of the first through twelfth aspects, process 1100 includes transmitting, to the UE, a configuration of a period of mandatory reflection associated with the backscatter device, wherein estimating the backscatter link channel matrix is performed during the period of mandatory reflection.

In a fourteenth aspect, alone or in combination with one or more of the first through thirteenth aspects, the configuration of the period of mandatory reflection indicates a start position of the period of mandatory reflection and a length of the period of mandatory reflection.

In a fifteenth aspect, alone or in combination with one or more of the first through fourteenth aspects, the configuration of the period of mandatory reflection indicates a periodicity of mandatory reflection.

In a sixteenth aspect, alone or in combination with one or more of the first through fifteenth aspects, during the period of mandatory reflection, the UE receives a transmission of a sequence of all one bits from the backscatter device.

In a seventeenth aspect, alone or in combination with one or more of the first through sixteenth aspects, process 1100 includes transmitting a transmission via the backscatter link, wherein the backscatter device reflects the transmission to the UE by turning on reflection when transmitting an information bit 1 and by turning off reflection when transmitting an information bit 0.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a base station, in accordance with the present disclosure. Example process 1200 is an example where the base station (e.g., base station 110) performs operations associated with beam determination and reporting in backscatter communication.

As shown in FIG. 12, in some aspects, process 1200 may include transmitting, to a UE, a configuration of an uplink transmission, wherein the UE is in wireless communication with the base station via a direct link and via a backscatter link reflected by a backscatter device (block 1210). For example, the base station (e.g., using communication manager 150 and/or transmission component 1404, depicted in FIG. 14) may transmit, to a UE, a configuration of an uplink transmission, wherein the UE is in wireless communication with the base station via a direct link and via a backscatter link reflected by a backscatter device, as described above.

As further shown in FIG. 12, in some aspects, process 1200 may include transmitting, to the backscatter device, a configuration of a period of mandatory reflection (block 1220). For example, the base station (e.g., using communication manager 150 and/or transmission component 1404, depicted in FIG. 14) may transmit, to the backscatter device, a configuration of a period of mandatory reflection, as described above.

As further shown in FIG. 12, in some aspects, process 1200 may include receiving, from the UE and based at least in part on the configuration of the uplink transmission, the uplink transmission via the direct link and via the backscatter link during the period of mandatory reflection (block 1230). For example, the base station (e.g., using communication manager 150 and/or reception component 1402, depicted in FIG. 14) may receive, from the UE and based at least in part on the configuration of the uplink transmission, the uplink transmission via the direct link and via the backscatter link during the period of mandatory reflection, as described above.

Process 1200 may include additional aspects, such as any single aspect or any combination of aspects described below and/or in connection with one or more other processes described elsewhere herein.

In a first aspect, process 1200 includes estimating a backscatter link channel matrix during the period of mandatory reflection.

In a second aspect, alone or in combination with the first aspect, process 1200 includes transmitting, to the UE, a configuration of a transmit beam associated with the backscatter link based at least in part on the backscatter link channel matrix.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include one or more of an estimation component 1308, or a determination component 1310, among other examples.

In some aspects, the apparatus 1300 may be configured to perform one or more operations described herein in connection with FIGS. 5-8. Additionally, or alternatively, the apparatus 1300 may be configured to perform one or more processes described herein, such as process 900 of FIG. 9, process 1000 of FIG. 10, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The reception component 1302 may receive, from a base station, a configuration of a beam report associated with a set of base station transmit beams, the set of base station transmit beams being directed to the UE via a backscatter link reflected by a backscatter device. The transmission component 1304 may transmit, to the base station, the beam report based at least in part on the configuration of the beam report, the beam report corresponding to the backscatter link.

The transmission component 1304 may transmit, to the base station, an indication of whether the beam report corresponds to a direct link between the base station and the UE or to the backscatter link.

The reception component 1302 may receive, from the base station, an indication of whether the beam report corresponds to a direct link between the base station and the UE or to the backscatter link.

The reception component 1302 may receive, from the base station, a transmission on a first base station transmit beam of the set of base station transmit beams based at least in part on the beam report, wherein the transmission is received via the backscatter link.

The reception component 1302 may receive, from the base station, multiple base station transmit beams including multiple CSI-RSs, wherein each base station transmit beam of the multiple base station transmit beams includes a corresponding CSI-RS.

The estimation component 1308 may estimate a direct link channel matrix based at least in part on the multiple CSI-RSs.

The reception component 1302 may receive, from the base station, a configuration of a period to suspend reflection associated with the backscatter device, wherein estimating the direct link channel matrix is performed during the period to suspend reflection.

The estimation component 1308 may estimate a corresponding direct link channel for each base station transmit beam of the multiple base station transmit beams based at least in part on the corresponding CSI-RS.

The estimation component 1308 may estimate a backscatter link channel matrix based at least in part on the direct link channel matrix.

The reception component 1302 may receive, from the base station, one or more repeat transmissions of the multiple CSI-RSs based at least in part on an SNR of the backscatter link satisfying a SNR threshold.

The reception component 1302 may receive, from the base station, multiple beam sweeps, wherein each beam sweep of the multiple beam sweeps includes the multiple base station transmit beams.

The estimation component 1308 may estimate the direct link channel matrix based at least in part on a first beam sweep of the multiple beam sweeps.

The estimation component 1308 may estimate the backscatter link channel matrix based at least in part on a second beam sweep of the multiple beam sweeps.

The determination component 1310 may determine a first base station transmit beam for the direct link based at least in part on the direct link channel matrix.

The determination component 1310 may determine a second base station transmit beam for the backscatter link based at least in part on the backscatter link channel matrix.

The reception component 1302 may receive, from the base station, a configuration of a period of mandatory reflection associated with the backscatter device, wherein estimating the backscatter link channel matrix is performed during the period of

The reception component 1302 may receive a transmission via the backscatter link, wherein the backscatter device reflects the transmission to the UE by turning on reflection when transmitting an information bit 1 and by turning off reflection when transmitting an information bit 0.

The reception component 1302 may receive, from a base station, a configuration of an uplink transmission, wherein the UE is in wireless communication with the base station via a direct link and via a backscatter link reflected by a backscatter device. The transmission component 1304 may transmit, to the base station and based at least in part on the configuration, the uplink transmission via the direct link and via the backscatter link during a period of mandatory reflection associated with the backscatter device.

The reception component 1302 may receive, from the base station, a configuration of a transmit beam associated with the backscatter link based at least in part on a measurement associated with the backscatter link during the period of mandatory reflection.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a base station, or a base station may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150 may include one or more of a configuration component 1408, or an estimation component 1410, among other examples.

In some aspects, the apparatus 1400 may be configured to perform one or more operations described herein in connection with FIGS. 5-8. Additionally, or alternatively, the apparatus 1400 may be configured to perform one or more processes described herein, such as process 1100 of FIG. 11, process 1200 of FIG. 12, or a combination thereof. In some aspects, the apparatus 1400 and/or one or more components shown in FIG. 14 may include one or more components of the base station described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the base station described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the base station described in connection with FIG. 2. In some aspects, the transmission component 1404 may be co-located with the reception component 1402 in a transceiver.

The transmission component 1404 and/or the configuration component 1408 may transmit, to a UE, a configuration of a beam report associated with a set of base station transmit beams, the set of base station transmit beams being directed to the UE via a backscatter link reflected by a backscatter device. The reception component 1402 may receive, from the UE, the beam report based at least in part on the configuration of the beam report, the beam report corresponding to the backscatter link.

The reception component 1402 may receive, from the UE, an indication of whether the beam report corresponds to a direct link between the base station and the UE or to the backscatter link.

The transmission component 1404 may transmit, to the UE, an indication of whether the beam report corresponds to a direct link between the base station and the UE or to the backscatter link.

The transmission component 1404 may transmit, to the UE, a transmission on a first base station transmit beam of the set of base station transmit beams based at least in part on the beam report, wherein the transmission is transmitted via the backscatter link.

The transmission component 1404 may transmit, to the UE, multiple base station transmit beams including multiple CSI-RSs, wherein each base station transmit beam of the multiple base station transmit beams includes a corresponding CSI-RS.

The reception component 1402 may receive, from the UE, an estimation of a direct link channel matrix based at least in part on the multiple CSI-RSs.

The transmission component 1404 may transmit, to the UE, a configuration of a period to suspend reflection associated with the backscatter device, wherein the UE estimates the direct link channel matrix during the period to suspend reflection.

The reception component 1402 may receive, from the UE, an estimation of a corresponding direct link channel for each base station transmit beam of the multiple base station transmit beams based at least in part on the corresponding CSI-RS.

The reception component 1402 may receive, from the UE, an estimation of a backscatter link channel matrix based at least in part on the direct link channel matrix.

The transmission component 1404 may transmit, to the UE, one or more repeat transmissions of the multiple CSI-RSs based at least in part on an SNR of the backscatter link satisfying a SNR threshold.

The transmission component 1404 may transmit, to the UE, multiple beam sweeps, wherein each beam sweep of the multiple beam sweeps includes the multiple base station transmit beams.

The reception component 1402 may receive, from the UE, the estimation of the direct link channel matrix based at least in part on a first beam sweep of the multiple beam sweeps.

The reception component 1402 may receive, from the UE, the estimation of the backscatter link channel matrix based at least in part on a second beam sweep of the multiple beam sweeps.

The transmission component 1404 and/or the configuration component 1408 may transmit, to the UE, a configuration of a period of mandatory reflection associated with the backscatter device, wherein estimating the backscatter link channel matrix is performed during the period of mandatory reflection.

The transmission component 1404 may transmit a transmission via the backscatter link, wherein the backscatter device reflects the transmission to the UE by turning on reflection when transmitting an information bit 1 and by turning off reflection when transmitting an information bit 0.

The transmission component 1404 and/or the configuration component 1408 may transmit, to a UE, a configuration of an uplink transmission, wherein the UE is in wireless communication with the base station via a direct link and via a backscatter link reflected by a backscatter device. The transmission component 1404 and/or the configuration component 1408 may transmit, to the backscatter device, a configuration of a period of mandatory reflection. The reception component 1402 may receive, from the UE and based at least in part on the configuration of the uplink transmission, the uplink transmission via the direct link and via the backscatter link during the period of

The estimation component 1410 may estimate a backscatter link channel matrix during the period of mandatory reflection.

The transmission component 1404 and/or the configuration component 1408 may transmit, to the UE, a configuration of a transmit beam associated with the backscatter link based at least in part on the backscatter link channel matrix.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:
Aspect 1: A method of wireless communication performed by a UE, comprising: receiving, from a base station, a configuration of a beam report associated with a set of base station transmit beams, the set of base station transmit beams being directed to the UE via a backscatter link reflected by a backscatter device; and transmitting, to the base station, the beam report based at least in part on the configuration of the beam report, the beam report corresponding to the backscatter link.
Aspect 2: The method of Aspect 1, further comprising transmitting, to the base station, an indication of whether the beam report corresponds to a direct link between the base station and the UE or to the backscatter link.
Aspect 3: The method of Aspect 1, further comprising receiving, from the base station, an indication of whether the beam report corresponds to a direct link between the base station and the UE or to the backscatter link.
Aspect 4: The method of any of Aspects 1-3, further comprising receiving, from the base station, a transmission on a first base station transmit beam of the set of base station transmit beams based at least in part on the beam report, wherein the transmission is received via the backscatter link.
Aspect 5: The method of any of Aspects 1-4, further comprising: receiving, from the base station, multiple base station transmit beams including multiple CSI-RSs, wherein each base station transmit beam of the multiple base station transmit beams includes a corresponding CSI-RS; and estimating a direct link channel matrix based at least in part on the multiple CSI-RSs.
Aspect 6: The method of Aspect 5, further comprising receiving, from the base station, a configuration of a period to suspend reflection associated with the backscatter device, wherein estimating the direct link channel matrix is performed during the period to suspend reflection.
Aspect 7: The method of Aspect 5, further comprising estimating a corresponding direct link channel for each base station transmit beam of the multiple base station transmit beams based at least in part on the corresponding CSI-RS.
Aspect 8: The method of Aspect 5, wherein the beam report indicates at least one of an RI, a PMI, or a CRI associated with each CSI-RS.
Aspect 9: The method of Aspect 5, wherein the beam report includes a pair of CQIs for each of the multiple base station transmit beams, wherein a first CQI of the pair of CQIs is associated with a transmission with a reflection of the backscatter device being activated, and wherein a second CQI of the pair of CQIs is associated with a transmission with the reflection of the backscatter device being deactivated.
Aspect 10: The method of Aspect 5, further comprising estimating a backscatter link channel matrix based at least in part on the direct link channel matrix.
Aspect 11: The method of Aspect 10, further comprising receiving, from the base station, one or more repeat transmissions of the multiple CSI-RSs based at least in part on an SNR of the backscatter link satisfying a SNR threshold.
Aspect 12: The method of Aspect 10, further comprising: receiving, from the base station, multiple beam sweeps, wherein each beam sweep of the multiple beam sweeps includes the multiple base station transmit beams; estimating the direct link channel matrix based at least in part on a first beam sweep of the multiple beam sweeps; and estimating the backscatter link channel matrix based at least in part on a second beam sweep of the multiple beam sweeps.
Aspect 13: The method of Aspect 12, wherein the base station transmit beams of the first beam sweep are QCL with corresponding base station transmit beams of the second beam sweep, and wherein a position of each of the base station transmit beams in the first beam sweep is the same as a position of the corresponding base station transmit beam in the second beam sweep.
Aspect 14: The method of Aspect 10, further comprising: determining a first base station transmit beam for the direct link based at least in part on the direct link channel matrix; and determining a second base station transmit beam for the backscatter link based at least in part on the backscatter link channel matrix.
Aspect 15: The method of Aspect 14, wherein the first base station transmit beam and the second base station transmit beam are determined based at least in part on determining a combined beamformed channel gain.
Aspect 16: The method of Aspect 14, wherein the first base station transmit beam is the same as the second base station transmit beam.
Aspect 17: The method of Aspect 14, wherein the first base station transmit beam is different than the second base station transmit beam.
Aspect 18: The method of Aspect 14, wherein the first base station transmit beam and the second base station transmit beam are determined based at least in part on a channel gain associated with at least one of the direct link or the backscatter link.
Aspect 19: The method of Aspect 10, further comprising receiving, from the base station, a configuration of a period of mandatory reflection associated with the backscatter device, wherein estimating the backscatter link channel matrix is performed during the period of mandatory reflection.
Aspect 20: The method of Aspect 19, wherein the configuration of the period of mandatory reflection indicates a start position of the period of mandatory reflection and a length of the period of mandatory reflection.
Aspect 21: The method of Aspect 19, wherein the configuration of the period of mandatory reflection indicates a periodicity of mandatory reflection.
Aspect 22: The method of Aspect 19, wherein, during the period of mandatory reflection, the UE receives a transmission of a sequence of all one bits from the backscatter device.
Aspect 23: The method of Aspect 19, further comprising receiving a transmission via the backscatter link, wherein the backscatter device reflects the transmission to the UE by turning on reflection when transmitting an information bit 1 and by turning off reflection when transmitting an information bit 0.
Aspect 24: A method of wireless communication performed by a UE, comprising: receiving, from a base station, a configuration of an uplink transmission, wherein the UE is in wireless communication with the base station via a direct link and via a backscatter link reflected by a backscatter device; and transmitting, to the base station and based at least in part on the configuration, the uplink transmission via the direct link and via the backscatter link during a period of mandatory reflection associated with the backscatter device.
Aspect 25: The method of Aspect 24, further comprising receiving, from the base station, a configuration of a transmit beam associated with the backscatter link based at least in part on a measurement associated with the backscatter link during the period of mandatory reflection.
Aspect 26: A method of wireless communication performed by a base station, comprising: transmitting, to a UE, a configuration of a beam report associated with a set of base station transmit beams, the set of base station transmit beams being directed to the UE via a backscatter link reflected by a backscatter device; and receiving, from the UE, the beam report based at least in part on the configuration of the beam report, the beam report corresponding to the backscatter link.
Aspect 27: The method of Aspect 26, further comprising receiving, from the UE, an indication of whether the beam report corresponds to a direct link between the base station and the UE or to the backscatter link.
Aspect 28: The method of Aspect 26, further comprising transmitting, to the UE, an indication of whether the beam report corresponds to a direct link between the base station and the UE or to the backscatter link.
Aspect 29: The method of any of Aspects 26-28, further comprising

transmitting, to the UE, a transmission on a first base station transmit beam of the set of base station transmit beams based at least in part on the beam report, wherein the transmission is transmitted via the backscatter link.
Aspect 30: The method of any of Aspects 26-28, further comprising: transmitting, to the UE, multiple base station transmit beams including multiple CSI-RSs, wherein each base station transmit beam of the multiple base station transmit beams includes a corresponding CSI-RS; and receiving, from the UE, an estimation of a direct link channel matrix based at least in part on the multiple CSI-RSs.
Aspect 31: The method of Aspect 30, further comprising transmitting, to the UE, a configuration of a period to suspend reflection associated with the backscatter device, wherein the UE estimates the direct link channel matrix during the period to suspend reflection.
Aspect 32: The method of Aspect 30, further comprising receiving, from the UE, an estimation of a corresponding direct link channel for each base station transmit beam of the multiple base station transmit beams based at least in part on the corresponding CSI-RS.
Aspect 33: The method of Aspect 30, wherein the beam report indicates at least one of an RI, a PMI, or a CRI associated with each CSI-RS.
Aspect 34: The method of Aspect 30, wherein the beam report includes a pair of CQIs for each of the multiple base station transmit beams, wherein a first CQI of the pair of CQIs is associated with a transmission with a reflection of the backscatter device being activated, and wherein a second CQI of the pair of CQIs is associated with a transmission with the reflection of the backscatter device being deactivated.
Aspect 35: The method of Aspect 30, further comprising receiving, from the UE, an estimation of a backscatter link channel matrix based at least in part on the direct link channel matrix.
Aspect 36: The method of Aspect 35, further comprising transmitting, to the UE, one or more repeat transmissions of the multiple CSI-RSs based at least in part on an SNR of the backscatter link satisfying a SNR threshold.
Aspect 37: The method of Aspect 35, further comprising: transmitting, to the UE, multiple beam sweeps, wherein each beam sweep of the multiple beam sweeps includes the multiple base station transmit beams; receiving, from the UE, the estimation of the direct link channel matrix based at least in part on a first beam sweep of the multiple beam sweeps; and receiving, from the UE, the estimation of the backscatter link channel matrix based at least in part on a second beam sweep of the multiple beam sweeps.
Aspect 38: The method of Aspect 37, wherein the base station transmit beams of the first beam sweep are QCL with corresponding base station transmit beams of the second beam sweep, and wherein a position of each of the base station transmit beams in the first beam sweep is the same as a position of the corresponding base station transmit beam in the second beam sweep.
Aspect 39: The method of Aspect 35, further comprising transmitting, to the UE, a configuration of a period of mandatory reflection associated with the backscatter device, wherein estimating the backscatter link channel matrix is performed during the period of mandatory reflection.
Aspect 40: The method of Aspect 39, wherein the configuration of the period of mandatory reflection indicates a start position of the period of mandatory reflection and a length of the period of mandatory reflection.
Aspect 41: The method of Aspect 39, wherein the configuration of the period of mandatory reflection indicates a periodicity of mandatory reflection.
Aspect 42: The method of Aspect 39, wherein, during the period of mandatory reflection, the UE receives a transmission of a sequence of all one bits from the backscatter device.
Aspect 43: The method of Aspect 39, further comprising transmitting a transmission via the backscatter link, wherein the backscatter device reflects the transmission to the UE by turning on reflection when transmitting an information bit 1 and by turning off reflection when transmitting an information bit 0.
Aspect 44: A method of wireless communication performed by a base station, comprising: transmitting, to a UE, a configuration of an uplink transmission, wherein the UE is in wireless communication with the base station via a direct link and via a backscatter link reflected by a backscatter device; transmitting, to the backscatter device, a configuration of a period of mandatory reflection; and receiving, from the UE and based at least in part on the configuration of the uplink transmission, the uplink transmission via the direct link and via the backscatter link during the period of mandatory reflection.
Aspect 45: The method of Aspect 44, further comprising estimating a backscatter link channel matrix during the period of mandatory reflection.
Aspect 46: The method of Aspect 45, further comprising transmitting, to the UE, a configuration of a transmit beam associated with the backscatter link based at least in part on the backscatter link channel matrix.
Aspect 47: An apparatus for wireless communication at a device, comprising a processor; memory coupled with the processor; and instructions stored in the memory and executable by the processor to cause the apparatus to perform the method of one or more of Aspects 1-23.
Aspect 48: A device for wireless communication, comprising a memory and one or more processors coupled to the memory, the one or more processors configured to perform the method of one or more of Aspects 1-23.
Aspect 49: An apparatus for wireless communication, comprising at least one means for performing the method of one or more of Aspects 1-23.
Aspect 50: A non-transitory computer-readable medium storing code for wireless communication, the code comprising instructions executable by a processor to perform the method of one or more of Aspects 1-23.
Aspect 51: A non-transitory computer-readable medium storing a set of instructions for wireless communication, the set of instructions comprising one or more instructions that, when executed by one or more processors of a device, cause the device to perform the method of one or more of Aspects 1-23.
Aspect 52: An apparatus for wireless communication at a device, comprising a processor; memory coupled with the processor; and instructions stored in the memory and executable by the processor to cause the apparatus to perform the method of one or more of Aspects 24-25.
Aspect 53: A device for wireless communication, comprising a memory and one or more processors coupled to the memory, the one or more processors configured to perform the method of one or more of Aspects 24-25.
Aspect 54: An apparatus for wireless communication, comprising at least one means for performing the method of one or more of Aspects 24-25.
Aspect 55: A non-transitory computer-readable medium storing code for wireless communication, the code comprising instructions executable by a processor to perform the method of one or more of Aspects 24-25.
Aspect 56: A non-transitory computer-readable medium storing a set of instructions for wireless communication, the set of instructions comprising one or more instructions that, when executed by one or more processors of a device, cause the device to perform the method of one or more of Aspects 24-25.
Aspect 57: An apparatus for wireless communication at a device, comprising a processor; memory coupled with the processor; and instructions stored in the memory and executable by the processor to cause the apparatus to perform the method of one or more of Aspects 26-43.
Aspect 58: A device for wireless communication, comprising a memory and one or more processors coupled to the memory, the one or more processors configured to perform the method of one or more of Aspects 26-43.
Aspect 59: An apparatus for wireless communication, comprising at least one means for performing the method of one or more of Aspects 26-43.
Aspect 60: A non-transitory computer-readable medium storing code for wireless communication, the code comprising instructions executable by a processor to perform the method of one or more of Aspects 26-43.
Aspect 61: A non-transitory computer-readable medium storing a set of instructions for wireless communication, the set of instructions comprising one or more instructions that, when executed by one or more processors of a device, cause the device to perform the method of one or more of Aspects 26-43.
Aspect 62: An apparatus for wireless communication at a device, comprising a processor; memory coupled with the processor; and instructions stored in the memory and executable by the processor to cause the apparatus to perform the method of one or more of Aspects 44-46.
Aspect 63: A device for wireless communication, comprising a memory and one or more processors coupled to the memory, the one or more processors configured to perform the method of one or more of Aspects 44-46.
Aspect 64: An apparatus for wireless communication, comprising at least one means for performing the method of one or more of Aspects 44-46.
Aspect 65: A non-transitory computer-readable medium storing code for wireless communication, the code comprising instructions executable by a processor to perform the method of one or more of Aspects 44-46.
Aspect 66: A non-transitory computer-readable medium storing a set of instructions for wireless communication, the set of instructions comprising one or more instructions that, when executed by one or more processors of a device, cause the device to perform the method of one or more of Aspects 44-46.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from a base station, a configuration of a beam report associated with a set of base station transmit beams, the set of base station transmit beams being directed to the UE via a backscatter link reflected by a backscatter device; and
transmit, to the base station, the beam report based at least in part on the configuration of the beam report, the beam report corresponding to the backscatter link.

2. The apparatus of claim 1, wherein the one or more processors are further configured to transmit, to the base station, an indication of whether the beam report corresponds to a direct link between the base station and the UE or to the backscatter link.

3. The apparatus of claim 1, wherein the one or more processors are further configured to receive, from the base station, an indication of whether the beam report corresponds to a direct link between the base station and the UE or to the backscatter link.

4. The apparatus of claim 1, wherein the one or more processors are further configured to receive, from the base station, a transmission on a first base station transmit beam of the set of base station transmit beams based at least in part on the beam report, wherein the transmission is received via the backscatter link.

5. The apparatus of claim 1, wherein the one or more processors are further configured to:
receive, from the base station, multiple base station transmit beams including multiple channel state information reference signals (CSI-RSs), wherein each base station transmit beam of the multiple base station transmit beams includes a corresponding CSI-RS; and
estimate a direct link channel matrix based at least in part on the multiple CSI-RSs.

6. The apparatus of claim 5, wherein the one or more processors are further configured to receive, from the base station, a configuration of a period to suspend reflection associated with the backscatter device, wherein estimating the direct link channel matrix is performed during the period to suspend reflection.

7. The apparatus of claim 5, wherein the beam report includes a pair of channel quality indicators (CQIs) for each of the multiple base station transmit beams, wherein a first CQI of the pair of CQIs is associated with a transmission with a reflection of the backscatter device being activated, and wherein a second CQI of the pair of CQIs is associated with a transmission with the reflection of the backscatter device being deactivated.

8. The apparatus of claim 5, wherein the one or more processors are further configured to estimate a backscatter link channel matrix based at least in part on the direct link channel matrix.

9. The apparatus of claim 8, wherein the one or more processors are further configured to:
receive, from the base station, multiple beam sweeps, wherein each beam sweep of the multiple beam sweeps includes the multiple base station transmit beams;
estimate the direct link channel matrix based at least in part on a first beam sweep of the multiple beam sweeps; and
estimate the backscatter link channel matrix based at least in part on a second beam sweep of the multiple beam sweeps.

10. The apparatus of claim 9, wherein the base station transmit beams of the first beam sweep are quasi co-located (QCL) with corresponding base station transmit beams of the second beam sweep, and wherein a position of each of the base station transmit beams in the first beam sweep is the same as a position of the corresponding base station transmit beam in the second beam sweep.

11. The apparatus of claim 8, wherein the one or more processors are further configured to receive, from the base station, a configuration of a period of mandatory reflection associated with the backscatter device, wherein estimating the backscatter link channel matrix is performed during the period of mandatory reflection.

12. The apparatus of claim 11, wherein, during the period of mandatory reflection, the UE receives a transmission of a sequence of all one bits from the backscatter device.

13. An apparatus for wireless communication at a user equipment (UE), comprising:
a memory; and
one or more processors, coupled to the memory, configured to:
receive, from a base station, a configuration of an uplink transmission, wherein the UE is in wireless communication with the base station via a direct link and via a backscatter link reflected by a backscatter device; and
transmit, to the base station and based at least in part on the configuration, the uplink transmission via the direct link and via the backscatter link during a period of mandatory reflection associated with the backscatter device.

14. The apparatus of claim 13, wherein the one or more processors are further configured to receive, from the base station, a configuration of a transmit beam associated with the backscatter link based at least in part on a measurement associated with the backscatter link during the period of mandatory reflection.

15. An apparatus for wireless communication at a base station, comprising:
a memory; and
one or more processors, coupled to the memory, configured to:
transmit, to a user equipment (UE), a configuration of a beam report associated with a set of base station transmit beams, the set of base station transmit beams being directed to the UE via a backscatter link reflected by a backscatter device; and
receive, from the UE, the beam report based at least in part on the configuration of the beam report, the beam report corresponding to the backscatter link.

16. The apparatus of claim 15, wherein the one or more processors are further configured to receive, from the UE, an indication of whether the beam report corresponds to a direct link between the base station and the UE or to the backscatter link.

17. The apparatus of claim 15, wherein the one or more processors are further configured to transmit, to the UE, an indication of whether the beam report corresponds to a direct link between the base station and the UE or to the backscatter link.

18. An apparatus for wireless communication at a base station, comprising:
a memory; and
one or more processors, coupled to the memory, configured to:
transmit, to a user equipment (UE), a configuration of an uplink transmission, wherein the UE is in wireless communication with the base station via a direct link and via a backscatter link reflected by a backscatter device;
transmit, to the backscatter device, a configuration of a period of mandatory reflection; and
receive, from the UE and based at least in part on the configuration of the uplink transmission, the uplink transmission via the direct link and via the backscatter link during the period of mandatory reflection.

19. The apparatus of claim 18, wherein the one or more processors are further configured to estimate a backscatter link channel matrix during the period of mandatory reflection.

20. The apparatus of claim 19, wherein the one or more processors are further configured to transmit, to the UE, a configuration of a transmit beam associated with the backscatter link based at least in part on the backscatter link channel matrix.
